(19) United States
(12) Patent Application Publication
(10) Pub. No.: US 2022/0377772 A1
(43) Pub. Date: Nov. 24, 2022

(54) BLIND DECODE AND CONTROL CHANNEL ELEMENT COUNTING FOR A COMMON SEARCH SPACE ON A SECONDARY CELL

(71) Applicant: QUALCOMM Incorporated, San Diego, CA (US)

(72) Inventors: Kazuki TAKEDA, Tokyo (JP); Huilin XU, Temecula, CA (US); Peter GAAL, San Diego, CA (US)

(21) Appl. No.: 17/664,192

(22) Filed: May 19, 2022

Related U.S. Application Data
(60) Provisional application No. 63/190,597, filed on May 19, 2021.

(51) Int. Cl. H04W 72/12; H04W 24/08; H04W 72/04

(52) U.S. Cl. CPC H04W 72/1273; H04W 24/08; H04W 72/0446; H04W 72/0453

(57) ABSTRACT

Certain aspects of the present disclosure provide techniques for blind decode and control channel element counting on a secondary cell. An example method may include receiving, from a network entity, signaling configuring the UE with a search space (SS) set on a primary cell (PCell) and a common search space (CSS) set on at least a first secondary cell (SCell). The method may also include monitoring at least one of the first SCell, the PCell, or a second SCell based on a count associated with a set of candidates for the CSS set on the first SCell against a number of PDCCH candidates or a number of CCEs, the set of candidates being at least one of physical downlink control channel (PDCCH) candidates or control channel elements (CCEs).

### CROSS REFERENCE TO RELATED APPLICATION(S)

This application claims the benefit of and priority to U.S. Provisional Application Ser. No. 63/190,597, entitled “Blind Decode and Control Channel Element Counting for a Common Search Space on a Secondary Cell” and filed on May 19, 2021, which is expressly incorporated by reference herein in its entirety.

### INTRODUCTION

Aspects of the present disclosure relate to wireless communications, and more particularly, to techniques for control channel monitoring and/or signaling.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### BRIEF SUMMARY

One aspect provides a method for wireless communication by a user equipment (UE). The method may generally include receiving, from a network entity, signaling configuring the UE with a search space (SS) set on a primary cell (PCell) and a common search space (CSS) set on at least a first secondary cell (SCell). The method may also include monitoring at least one of the first SCell, the PCell, or a second SCell based on a count associated with a set of candidates for the CSS set on the first SCell against a number of PDCCH candidates or a number of CCEs, the set of candidates being at least one of physical downlink control channel (PDCCH) candidates or control channel elements (CCEs).

One aspect provides a method for wireless communication by a network entity. The method may generally include transmitting, for a UE, signaling configuring the UE with a SS set on a PCell and a CSS set on at least a first SCell. The method may further include determining how to count at least one of PDCCH candidates or CCEs for the CSS set on the first SCell against a number of PDCCH candidates or a number of CCEs. The method may also include transmitting additional signaling in the CSS set on the first SCell in accordance with the determination.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 depicts an example of control resource sets (CORESETs) within a carrier bandwidth across a slot.

FIG. 5 depicts example CORESETs arranged within a span of symbols.

FIG. 6 depicts an example of same cell scheduling on a primary cell and a secondary cell.

FIG. 7 depicts example constraints for the number of physical downlink control channel (PDCCH) candidates that a user equipment may expect to monitor across a plurality of cells.

FIG. 8 depicts other example constraints for the number of physical downlink control channel (PDCCH) candidates that a user equipment may expect to monitor across a plurality of cells.

FIG. 9 depicts an example signaling flow for monitoring control channels.

FIG. 10 depicts an example method for control channel monitoring.

FIG. 11 depicts an example method for control channel signaling.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for physical downlink control channel (PDCCH) candidate and control channel element (CCE) counting for a common search space on a secondary cell.

A user equipment may be capable of processing a certain number of PDCCH blind decodes (e.g., PDCCH candidates) and/or a certain number of non-overlapping CCEs per slot or per span for a given cell. The number of PDCCH candidates and/or the number of non-overlapping CCEs supported by a UE may impact the cost and/or size of a modem (e.g., the number of parallel blind decoders on a chipset) used to process the blind decoding on control channels. For example, a modem chipset that is a capable of processing a large number of PDCCH candidates and/or CCEs may be more expensive to fabricate and have a larger footprint than another modem chipset with support for fewer PDCCH candidates. The number of PDCCH candidates and/or the number of non-overlapping CCEs supported by a UE may impact the power consumption of the device, such that a UE configured with too many PDCCH candidates and/or CCEs may lead to undesirable battery life. Although the UE may be configured with certain constraints on the PDCCH candidates and/or CCEs for control signaling, there may be ambiguities on how to treat the PDCCH candidates and/or CCEs of a common search space (CSS) in certain cases, such as on a secondary cell configured with a CSS and UE-specific search space. For example, it may be unclear how to count the PDCCH candidates and/or CCEs for a CSS on the secondary cell against the corresponding numbers for same cell scheduling, cross-carrier scheduling to another secondary cell, and/or cross-carrier scheduling to the primary cell.

Aspects of the present disclosure provide apparatus and techniques for PDCCH candidate and CCE counting for a common search space on a secondary cell, in particular, for counting corresponding numbers for a CSS and USS in the same span and/or slot on the secondary cell. That is, the UE may have shared parameters for monitoring the CSS and USS in the same span and/or slot on the secondary cell. The monitoring capability may be allocated to monitoring on a secondary cell in terms of a number of PDCCH candidates and/or a number of CCEs, and the corresponding numbers for the secondary cell may be shared between monitoring the CSS and the USS. For example, the number of PDCCH candidates and the number of non-overlapped CCEs for the CSS may be counted as part of the corresponding numbers for self-scheduling (i.e., same cell scheduling) on the secondary cell. The number of PDCCH candidates and the number of non-overlapped CCEs for the CSS may be counted as part of the corresponding numbers for any scheduled cell (e.g., same cell scheduling and cross-carrier scheduling) on the secondary cell. In certain cases, the CSS may include a Type 3 PDCCH that can be configured with a USS, for example, a Type 3 PDCCH having a cyclic redundancy check (CRC) scrambled by a certain type of radio network temporary identifier(s) RNTI,

The rule(s) for counting PDCCH candidates and/or CCEs described herein may enable desirable performance (e.g., desirable latencies, data rates, and/or spectral efficiencies) in carrier aggregation and/or dual connectivity applications, for example, due to the multiple carriers allowed for common and/or UE-specific control signaling. In aspects, the rule(s) for counting PDCCH candidates and/or CCEs described herein may enable desirable battery life, for example, due to the power consumption allowed for monitoring control signaling in accordance with the rule(s). In aspects, the rule(s) for counting PDCCH candidates and/or CCEs described herein may enable desirable modem chipset cost and/or size, for example, due to the constraints on control signaling provided by the rule(s).

Introduction to Wireless Communication Networks

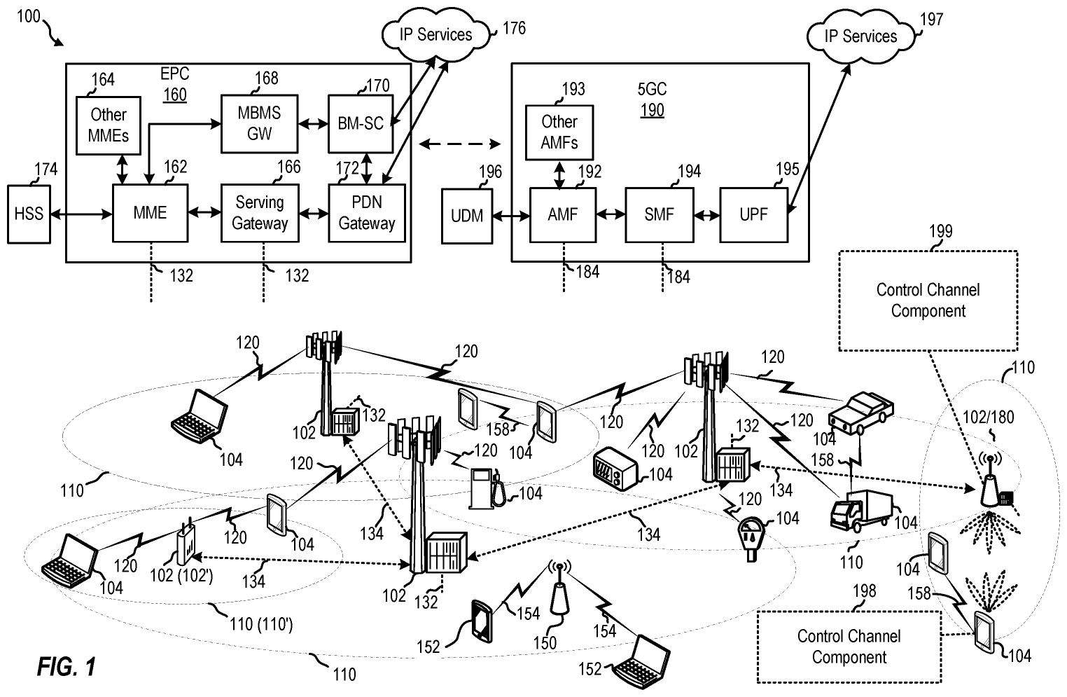

FIG. 1 depicts an example of a wireless communications system 100, in which aspects described herein may be implemented.

Generally, wireless communications system 100 includes base stations (BSs) 102, one or more user equipment (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a next generation node B (gNB), NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Wireless communication system 100 includes control channel component 199, which may determine how to count control channel candidates and/or control channel elements at a base station 102 for a common search space on a secondary cell, for example, when a UE is configured with a common search space and a UE-specific search space on the secondary cell. Wireless communication system 100 further includes control channel component 198, which may determine how to count control channel candidates and/or control channel elements at a UE 104 for a common search space on a secondary cell.

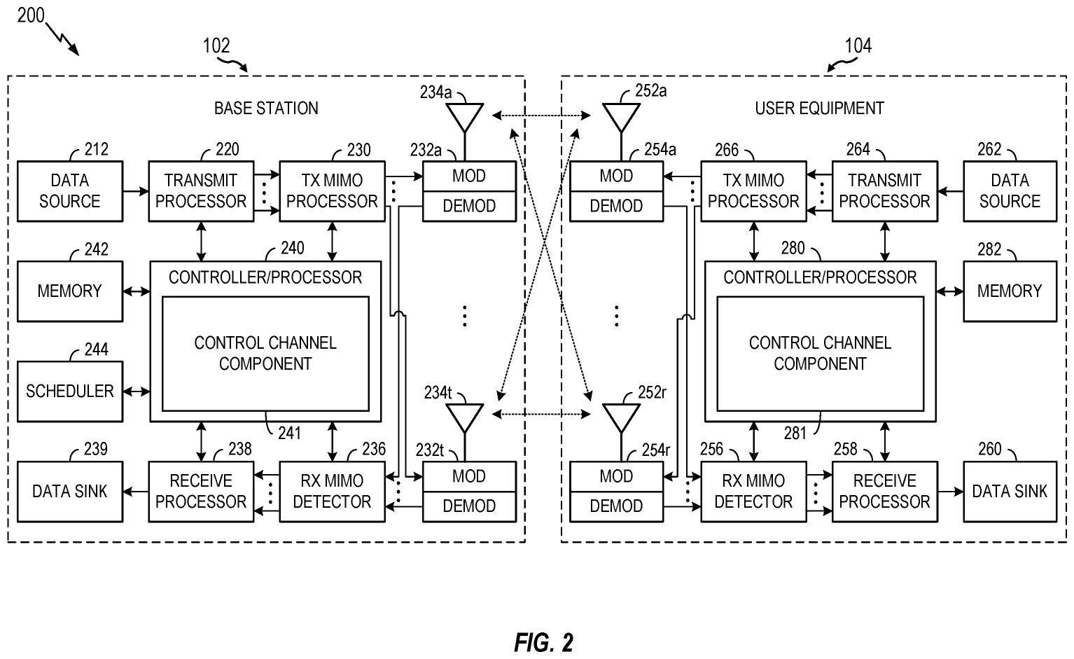

FIG. 2 is a diagram 200 depicting aspects of an example base station (BS) 102 and a user equipment (UE) 104.

Generally, base station 102 includes various processors (e.g., 220, 230, 238, and 240), antennas 234a-234t, transceivers 232a-232t, which include modulators and demodulators, and other aspects, which enable wireless transmission of data (e.g., data from data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes control channel component 241, which may be representative of the control channel component 199 of FIG. 1. Notably, while depicted as an aspect of controller/processor 240, the control channel component 241 may be implemented additionally or alternatively in various other aspects of base station 102 in other implementations.

Generally, user equipment 104 includes various processors (e.g., 258, 264, 266, and 280), antennas 252a-252r, transceivers 254a-254r, which include modulators and demodulators, and other aspects, which enable wireless transmission of data (e.g., data from data source 262) and wireless reception of data (e.g., data sink 260).

User equipment 104 includes controller/processor 280, which may be configured to implement various functions related to wireless communications. In the depicted example, controller/processor 280 includes a control channel component 281, which may be representative of the control channel component 198 of FIG. 1. Notably, while depicted as an aspect of controller/processor 280, the control channel component 281 may be implemented additionally or alternatively in various other aspects of user equipment 104 in other implementations.

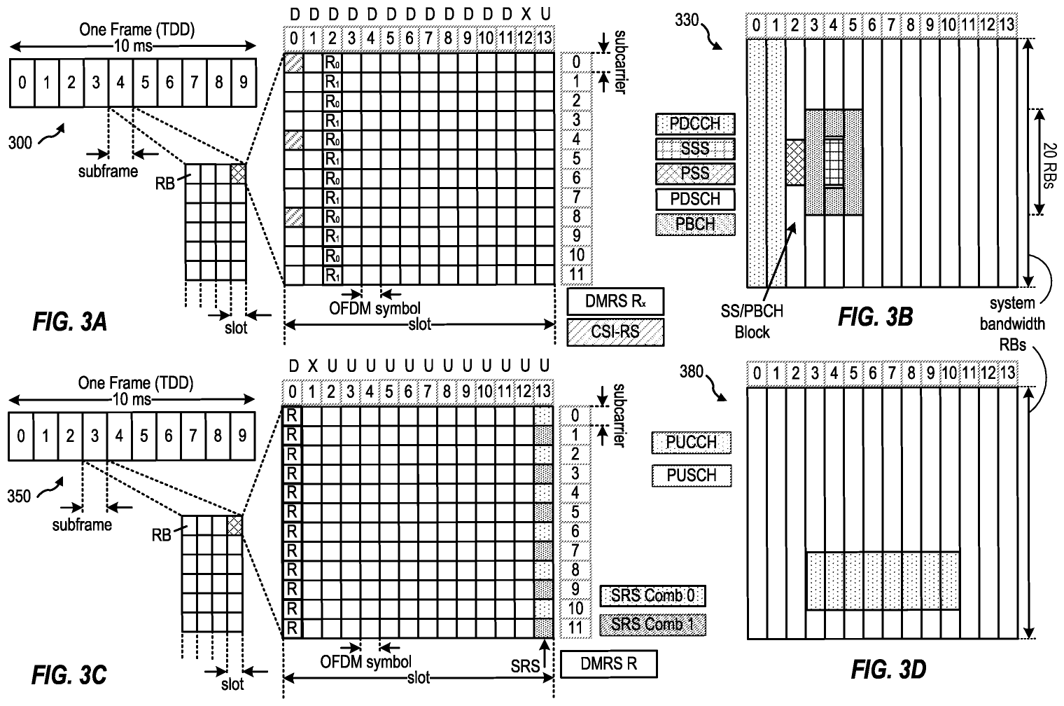

FIGS. 3A-3D depict aspects of data structures for a wireless communication network, such as wireless communication system 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

Introduction to Control Channel Signaling

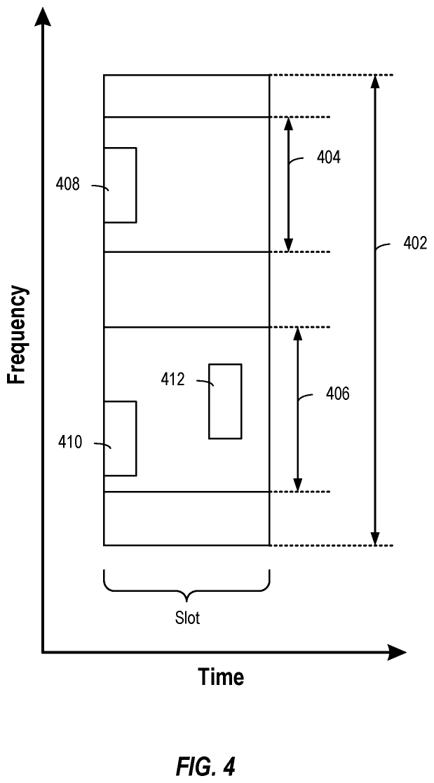

In certain wireless communication systems (e.g., LTE), the PDCCH is allocated across an entire system bandwidth, whereas in NR systems, the PDCCH is transmitted in the control resource sets (CORESETs) of an active bandwidth part (BWP). FIG. 4 is a diagram illustrating an example of control resource sets (CORESETs) within a carrier bandwidth across a slot in NR. As shown, a carrier bandwidth (CBW) 402 may have multiple bandwidth parts (BWPs) 404, 406 at various subcarrier spacings (SCS). In this example, the BWP 404 is configured with a single CORESET 408. In aspects, a BWP may be configured with multiple CORESETs. For example, the BWP 406 is configured with two CORESETs 410, 412. Each of the CORESETs 408, 410, 412 include a set of physical resources within a specific area in a downlink resource grid and are used, for example, to carry downlink control information (DCI), system information, paging information, and/or random access responses (RARs).

In a CORESET, the set of resource blocks (RBs) and the number of consecutive OFDM symbols in which the CORESET is located are configurable with a CORESET configuration, and the time domain location of the OFDM symbols is configurable with corresponding PDCCH search space (SS) set(s). A search space set may be configured with a specific type (e.g., common search space (CSS) set or a UE-specific search space (USS) set), a DCI format to be monitored, a monitoring occasion, and the number of PDCCH candidates (e.g., blind decodes) for each aggregation level (AL) in the SS set. In other words, a search space set is a set of one or more search spaces, where each search space corresponds to an AL (e.g., the number of control channel elements for a PDCCH candidate). For example, in some wireless communication systems, AL 1 may have one CCE; AL 2 may have two CCEs; AL 4 may have four CCEs; AL 8 may have eight CCEs; and AL 16 may have 16 CCEs. The configuration flexibilities of control regions (e.g., CORESETs and associated search space sets) including time, frequency, numerologies, and operating points enable wireless communication systems to address a wide range of use cases for control signaling (e.g., various desired latencies and/or various channel conditions).

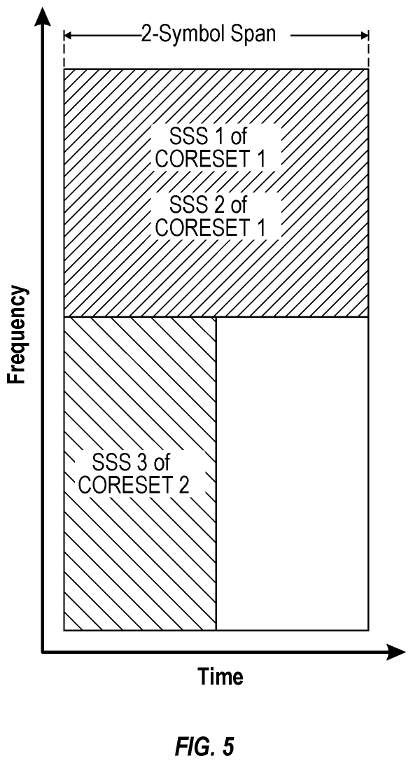

FIG. 5 is a diagram illustrating example CORESETs arranged within a span of symbols, in accordance with certain aspects of the present disclosure. As shown, two CORESETs (CORESET 1 and CORESET 2) are arranged within a 2-symbol span where two search space sets (SSS 1 and SSS 2) are fully overlapping in CORESET 1, and CORESET 2 is configured with a separate search set (SSS 3). As an example, the SSS 1 may be a CSS; and SSS 2 and SSS 3 may be USSs. Each search space set of a given CORESET (e.g., SSS 1-3) may be configured with a number of PDCCH candidates per AL. For example, a search space set may include a number of PDCCH candidates Mₛ^{(L)} per CCE aggregation level L, for example, by CCE aggregation level 1, CCE aggregation level 2, CCE aggregation level 4, CCE aggregation level 8, and CCE aggregation level 16, respectively. In aspects, a PDCCH candidate may refer to a certain number of CCEs at a specific CCE aggregation level (e.g., AL 1, 2, 4, or 16) in a search space set. In certain aspects, a search space set may be referred to as a search space. A span of symbols may include a certain number of consecutive symbols in a slot, and in certain cases, a span of symbols may be referred to as a span.

A specific type of PDCCH may be associated with a specific CSS according to the content of the control signaling carried on the PDCCH. For example, Type 0 may carry system information (e.g., the RMSI) in the master information block (MIB) and SIB1; Type 0A may carry other system information (OSI); Type 1 may carry the random access responses (RAR); Type 2 may carry paging signals; and Type 3 may carry common control signals.

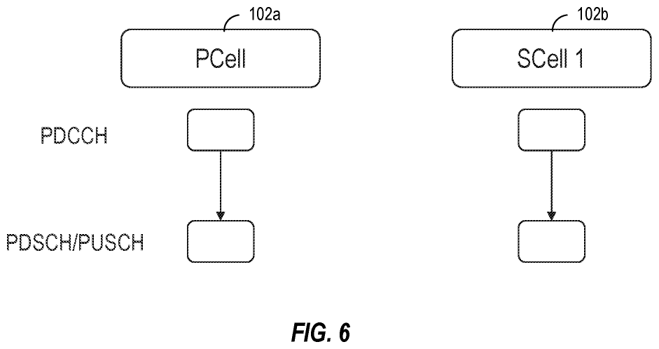

In some wireless communication systems, the UE may support same cell scheduling on multiple cells, such as a primary cell and secondary cell(s). For example, FIG. 6 depicts same cell scheduling on a primary cell 102a and secondary cell 102b, where a PDCCH on the primary cell 102a or the secondary cell 102b may schedule resources in the PDSCH/PUSCH on the primary cell 102a or the secondary cell 102b.

The UE may also support cross-carrier scheduling on the primary cell to the secondary cell, and the UE may support cross-carrier scheduling on the secondary cell to another secondary cell. For cross-carrier scheduling, the number of PDCCH candidates for monitoring and the number of non-overlapped CCEs per span or per slot may be separately counted for each scheduled cell.

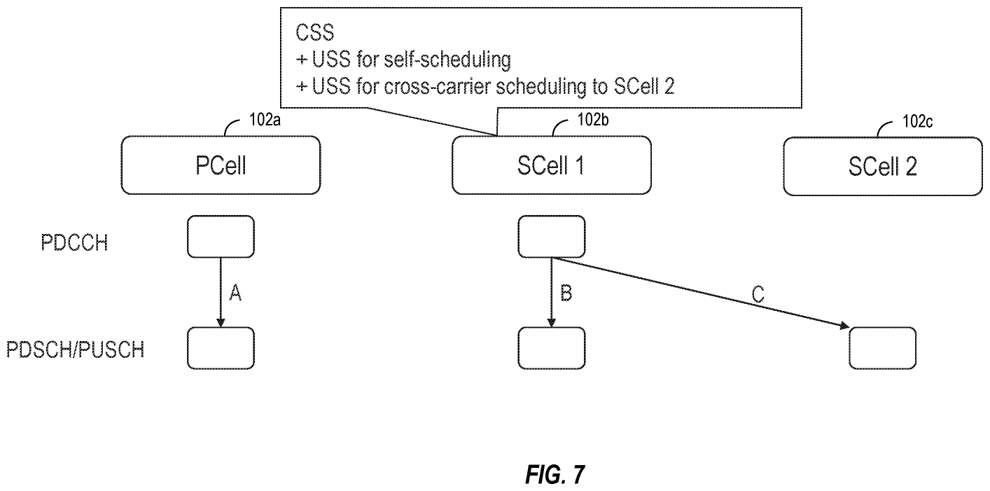

FIG. 7 is a diagram illustrating example constraints for the number of PDCCH candidates that a UE may expect to monitor across a plurality of cells for cross-carrier scheduling and/or same cell scheduling. In this example, the UE may support and/or be configured with A PDCCH candidates for same cell scheduling on the primary cell 102a (PCell), B PDCCH candidates for same cell scheduling on the secondary cell 102b (SCell 1), and/or C PDCCH candidates for cross-carrier scheduling on the secondary cell 102b to another secondary cell 102c (SCell 2).

A UE can be configured with a USS set and/or a Type 3 PDCCH CSS set on a primary cell or a secondary cell. In such a case, the Type 3 PDCCH CSS set may carry DCI formats with a cyclic redundancy check (CRC) scrambled by various radio network temporary identifiers (RNTIs), such as the interruption RNTI (INT-RNTI), slot format indication RNTI (SFI-RNTI), Transmit Power Control (TPC)-PUSCH-RNTI, TPC-PUCCH-RNTI, or TPC-SRS-RNTI. The Type 0 PDCCH CSS set, Type 0A PDCCH CSS set, Type 2 PDCCH CSS set, and/or Type 3 PDCCH CSS set carrying DCI formats with a CRC scrambled by cell RNTI (C-RNTI), modulation coding scheme cell RNTI (MCS-C-RNTI), or configured scheduling RNTI (CS-RNTI) may be configured on the primary cell (e.g., the primary cell in a master cell group and/or a secondary cell group).

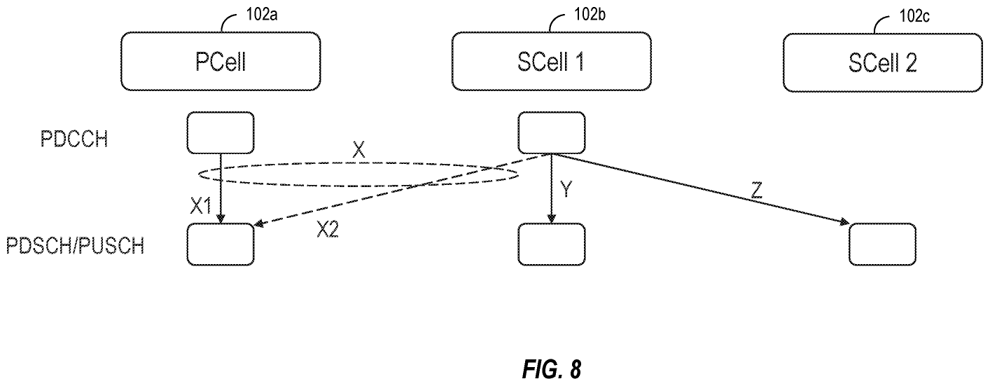

FIG. 8 is a diagram illustrating other example constraints for the number of PDCCH candidates that a UE may expect to monitor across a plurality of cells for cross-carrier scheduling and/or same cell scheduling. In this example, the UE may support and/or be configured with X1 PDCCH candidates for same cell scheduling on the primary cell 102a (PCell), X2 PDCCH candidates for cross-carrier scheduling on the secondary cell 102b (SCell 1) to the primary cell 102a, Y PDCCH candidates for same cell scheduling on the secondary cell 102b, and/or Z PDCCH candidates for cross-carrier scheduling on the secondary cell 102b to another secondary cell 102c (SCell 2). That is, the UE may be configured with and/or be capable of monitoring X1, X2, Y, and Z PDCCH candidates on each of the scheduled cells including the primary cell 102a, the secondary cell 102b, and the other secondary cell 102c, respectively.

In certain cases, the UE may support and/or be configured with PDCCH monitoring on the primary cell 102a and the secondary cell 102b for scheduling data on the primary cell 102a via same cell scheduling on the primary cell 102a and/or cross-carrier scheduling on the secondary cell 102b. A constraint to monitor for same cell scheduling on the primary cell 102a and cross-carrier scheduling to the primary cell 102a from the secondary cell 102b may be represented by X PDCCH candidates, where X may be the sum of X1 and X2. That is, a maximum number of PDCCH candidates (X) across the search space sets on the primary cell 102a and the secondary cell 102b for scheduling data on the primary cell 102a may be specified. In certain cases, individual maximum numbers of PDCCH candidates (X1, X2) for the search space sets for scheduling data to the primary cell 102a on the primary cell 102a and the secondary cell 102b may be specified. Each of the numbers (X, X1, X2, Y, and/or X) for counting PDCCH candidates on a scheduled cell may have a separate value. Each of the numbers (X, X1, X2, Y, and/or X) for counting PDCCH candidates may represent the maximum number of PDCCH candidates that the UE can monitor per slot or per span of symbols or a constraint that caps the number of PDCCH candidates that UE may monitor per slot or per span of symbols.

While the examples depicted in FIGS. 7 and 8 are described herein with respect to A, B, C, X, X1, X2, Y, and Z representing certain numbers of PDCCH candidates to facilitate understanding, aspects of the present disclosure may also be applied to A, B, C, X, X1, X2, Y, and Z representing certain numbers of non-overlapped CCEs. The corresponding number of non-overlapped CCEs may have separate values from the corresponding numbers of PDCCH candidates.

The primary cell and secondary cell(s) may be cells with separate carriers in a carrier aggregation setting and/or dual connectivity setting. That is, each of the cells among the primary cell and secondary cell(s) may provide separate radio resources for wireless communications between one or more network entities and a UE. In certain aspects, a primary cell may refer to a cell, operating on the primary frequency, in which the UE either performs the initial connection establishment procedure or initiates the connection re-establishment procedure, and the secondary cell may refer to a cell providing additional radio resources on top of primary cell, for a UE configured with carrier aggregation.

A UE may be capable of processing a certain number of PDCCH blind decodes (e.g., PDCCH candidates) and/or a certain number of non-overlapping CCEs per slot or per span for a given cell. The number of PDCCH candidates and/or the number of non-overlapping CCEs supported by a UE may impact the cost and/or size of a modem (e.g., the number of parallel blind decoders on a chipset) used to process the blind decoding on control channels. For example, a modem chipset that is a capable of processing a large number of PDCCH candidates and/or CCEs may be more expensive to fabricate and have a larger footprint than another modem chipset with support for fewer PDCCH candidates. The number of PDCCH candidates and/or the number of non-overlapping CCEs supported by a UE may impact the power consumption of the device, such that a UE configured with too many PDCCH candidates and/or CCEs may lead to undesirable battery life.

Although the UE may be configured with certain constraints on the PDCCH candidates and/or CCEs for control signaling, for example, as described herein with respect to FIGS. 7 and 8, there may be ambiguities on how to treat the PDCCH candidates and/or CCEs of a CSS in certain cases, such as on a SCell configured with a CSS and USS. For example, it may be unclear how to count the PDCCH candidates and/or CCEs for a CSS on the SCell against the corresponding numbers for same cell scheduling, cross-carrier scheduling to another SCell, and/or cross-carrier scheduling to the PCell. Accordingly, what is needed are techniques and apparatus for PDCCH candidate and CCE counting for a CSS on a secondary cell.

Aspects Related to Blind Decode and Control Channel Element Counting for a Common Search Space on a Secondary Cell

Aspects of the present disclosure provide apparatus and techniques for PDCCH candidate and CCE counting for a common search space on a secondary cell, in particular, for counting corresponding numbers for a CSS and USS in the same span and/or slot on the secondary cell. That is, the UE may have shared parameters for monitoring the CSS and USS in the same span and/or slot on the secondary cell. The monitoring capability may be allocated to monitoring on a secondary cell in terms of a number of PDCCH candidates and/or a number of CCEs, and the corresponding numbers for the secondary cell may be shared between monitoring the CSS and the USS. For example, the number of PDCCH candidates and the number of non-overlapped CCEs for the CSS may be counted as part of the corresponding numbers for self-scheduling (i.e., same cell scheduling) on the secondary cell. The number of PDCCH candidates and the number of non-overlapped CCEs for the CSS may be counted as part of the corresponding numbers for any scheduled cell (e.g., same cell scheduling and cross-carrier scheduling) on the secondary cell. In certain cases, the CSS may include a Type 3 PDCCH that can be configured with a USS, for example, a Type 3 PDCCH having a CRC scrambled by INT-RNTI, SFI-RNTI, TPC-PUSCH-RNTI, TPC-PUCCH-RNTI, or TPC-SRS-RNTI.

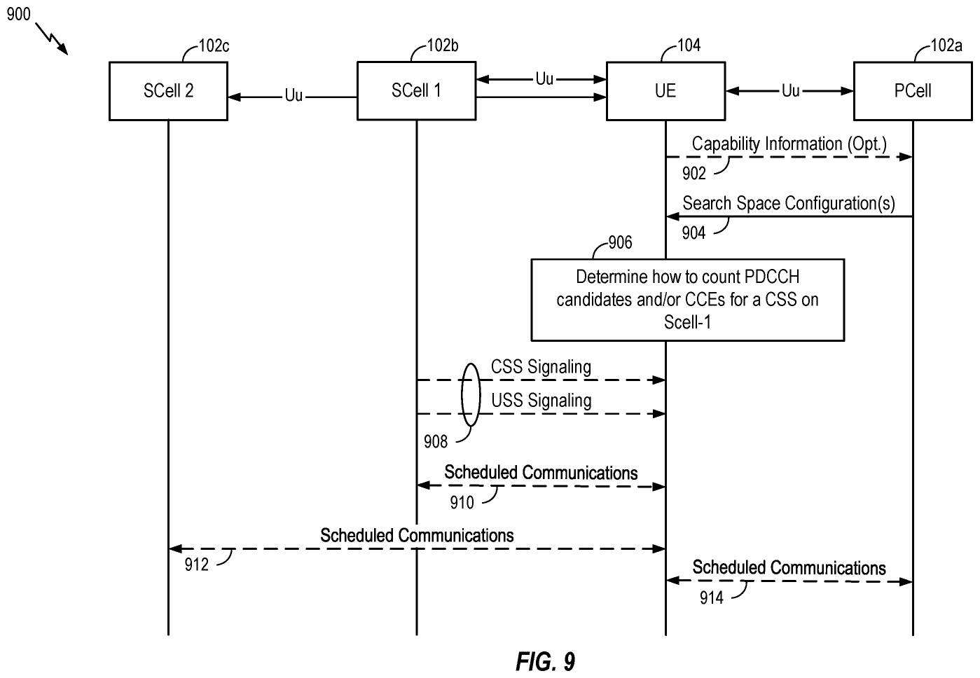

FIG. 9 depicts an example signaling flow 900 for monitoring control channels. The flow may begin at step 902, where the UE 104 may transmit capability information to the PCell 102a. The capability information may provide the corresponding numbers for PDCCH candidates and/or CCEs that the UE is capable of monitoring per span of symbols and/or per slot. The capability information may provide the corresponding numbers for PDCCH candidates and/or CCEs for each scheduled cell (PCell, SCell, and/or at least another SCell).

At step 904, the UE 104 may receive, from the PCell 102a, one or more search space configurations for a CSS and/or USS. For example, the UE 104 may derive CSS for Type 0 PDCCH from system information received at step 904. As an example, the UE 104 may receive radio resource control (RRC) signaling providing other CSS and/or USS configurations at step 904. In certain cases, the UE 104 may be configured with a CSS and a USS on the SCell 102b (SCell-1) at step 904. The CSS may be associated with a specific type of PDCCH, such as Type 3 PDCCH.

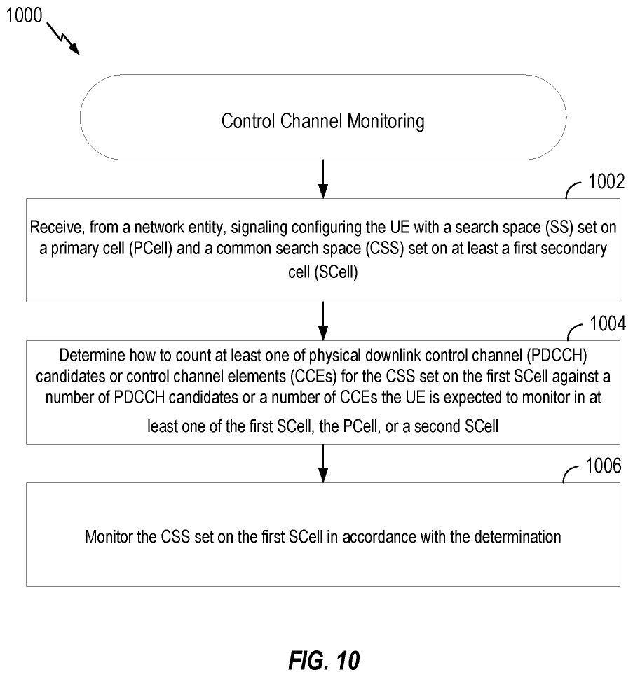

At step 906, the UE 104 may determine how to count PDCCH candidates and/or CCEs for the CSS on the SCell 102b. The UE 104 may count the PDDCH candidates and/or CCEs for the CSS against the corresponding numbers for any scheduled cell on the SCell 102b, for example, as further described herein with respect to FIG. 10. As an example, the UE 104 may count the PDCCH candidates and/or CCEs for the CSS against the corresponding numbers for same cell scheduling on the SCell 102b (e.g., Y for PDCCH candidates and/or CCEs as depicted in FIG. 8). In certain cases, the determination at step 906 may involve applying the configuration(s) received at step 904, which may be configured to comply with certain counting rule(s) for the UE. That is, the search space configuration(s) received at 904 may satisfy the PDCCH candidate and/or CCE counting rule(s) applicable when the UE is configured with a USS and CSS on a secondary cell. In certain cases, the PDCCH candidate and/or CCE counting rule(s) may be preconfigured at the UE 104 or configured by the network, such as PCell 102a.

At step 908, the UE 104 may receive control signaling in at least one of the CSS or USS on the SCell 102b in accordance with the counting rule(s) determined at step 906. Step 908 may involve the UE 104 monitoring for control signaling in the CSS and/or USS in accordance with the determination at step 906. That is, the UE 104 may perform blind decodes on PDCCH candidates in the CSS and/or USS subject to the constraints for the maximum number of PDCCH candidates and/or CCEs determined at step 906. The UE 104 may expect to monitor a certain number of PDCCH candidates and/or CCEs shared between monitoring for the USS and/or CSS per span of symbols and/or per slot. That is, the number of PDCCH candidates and/or CCEs for the CSS may be part of the corresponding number for any scheduled cell on the SCell 102b. At step 908, the UE 104 may receive common control signaling on the SCell 102b, same cell scheduling on the SCell 102b, and/or cross-carrier scheduling to the SCell 102c and/or the PCell 102a.

At step 910, the UE 104 may communicate on the SCell 102b based on the same cell scheduling received at step 908. For example, the UE 104 may receive downlink data in resources on the SCell 102b indicated in the same cell scheduling.

Additionally or alternatively, at step 912, the UE 104 may communicate on the SCell 102c based on the cross-carrier scheduling received at step 908. For example, the UE 104 may transmit uplink data in resources on the SCell 102c indicated in the cross-carrier scheduling.

Additionally or alternatively, at step 914, the UE 104 may communicate on the PCell 102a based on the cross-carrier scheduling received at step 908. As an example, the UE 104 may receive downlink data in resources on the PCell 102a indicated in the cross-carrier scheduling.

### Example Methods of Blind Decode and Control Channel Element Counting for a Common Search Space on a Secondary Cell

FIG. 10 depicts an example method 1000 for control channel monitoring, for example, in accordance with the counting rule(s) for PDCCH candidates and/or CCEs of a common search space on a secondary cell.

The method 1000 may begin, at step 1002, where the UE (e.g., the UE 104) may receive, from a network entity, signaling configuring the UE with a search space (SS) set on a primary cell (PCell) (e.g., the primary cell 102a depicted in FIGS. 7-9) and a common search space (CSS) set on at least a first secondary cell (SCell) (e.g., the secondary cell 102b depicted in FIGS. 7-9). For example, the UE may receive control signaling that provides the search space configuration, such as radio resource control (RRC) signaling, downlink control information (DCI), medium access control (MAC) signaling, and/or system information. In certain cases, certain search spaces (e.g., a CSS for Type 0 PDCCH) at step 1002 may be derived from system information, and certain search spaces (e.g., other CSS(s) and/or USS(s)) may be configured via RRC signaling, such as the SearchSpace information element. In aspects, the signaling at 1002 may also configure the UE with a USS set on the first SCell. The network entity may be a network node. The network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a central unit (CU), a distributed unit (DU), a radio/remote unit (RU), a Near-Real Time (Near-RT) RAN Intelligent Controller (RIC), or a Non-Real Time (Non-RT) RIC.

At step 1004, the UE may determine how to count at least one of PDCCH candidates or CCEs for the CSS set on the first SCell against a number of PDCCH candidates or a number of CCEs the UE is expected to monitor in at least one of the first SCell, the PCell, or a second SCell (e.g., the other secondary cell 102c depicted in FIGS. 7-9). In certain cases, the UE may be preconfigured or configured by the network with one or more rules for counting PDCCH candidates and/or CCEs that the UE expects to monitor in search space(s) across one or more cells such as the PCell, first SCell, and/or the second SCell. For example, for same cell scheduling or for cross-carrier scheduling, the UE may not expect a number of PDCCH candidates, and a number of corresponding non-overlapped CCEs per slot or per span on a secondary cell to be larger than the corresponding numbers that the UE is capable of monitoring on the secondary cell per slot or per span, respectively.

At step 1006, the UE may monitor the CSS set on the first SCell in accordance with the determination. Monitoring at step 1006 may involve the UE performing blind decodes on PDCCH candidates at certain aggregation levels in monitoring occasions associated with one or more search spaces. The UE may monitor for signals from the network entity on the SCell in monitoring occasions associated with the CSS set, for example, as depicted in FIGS. 4 and 5. In the search spaces, the UE may monitor for system information, paging, RRC signaling, a random access response, UE-specific uplink and/or downlink grant(s), and/or UE-specific downlink control information from the network entity on the SCell. In aspects, the uplink and/or downlink grant(s) may be for same cell scheduling and/or cross-carrier scheduling to the PCell and/or the second SCell. That is, the uplink and/or downlink grant(s) may schedule a transmission and/or reception on the same cell on which the resource grant was received or a different cell (e.g., the PCell or the second SCell). The network entity may be a network node. The network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (MC), or a Non-Real Time (Non-RT) MC.

Aspects of the present disclosure provide specific rule(s) for counting PDCCH candidates and/or CCEs when the UE may be configured with a CSS and a USS on a secondary cell. That is, the UE may determine how to count the PDCCH candidates and/or CCEs for the CSS set on the first SCell as described herein if the UE is configured with the CSS set and a USS set on the first SCell. The rules for counting PDCCH candidates and/or CCEs described herein may be applied separately (i.e., on an individual basis) or in various combinations with each other. The rule(s) for counting PDCCH candidates and/or CCEs described herein may provide the number of PDCCH candidates and/or the number of non-overlapped CCEs that the UE expects to monitor in search space(s) per slot or per span.

For certain aspects, the PDCCH candidates and/or CCEs for the CSS set may be counted against at least one of the corresponding numbers for a scheduled cell among the primary cell, the secondary cell, and any other secondary cell(s). Referring to FIG. 8, the PDCCH candidates and/or CCEs for the CSS set may be counted against the corresponding numbers for same cell scheduling (e.g., Y for PDCCH candidates and/or CCEs) and/or the corresponding numbers for cross-carrier scheduling (e.g., Z and/or X2 for PDCCH candidates and/or CCEs) on the secondary cell in which the CSS set is configured. In certain cases, the PDCCH candidates and/or CCEs for the CSS set may be counted against the minimum (or maximum) corresponding number among the scheduled cells on the secondary cell. For example, the PDCCH candidates and/or CCEs for the CSS set may be counted against the minimum (or maximum) corresponding number among at least Y and Z (and X2). At step 1004, the UE may determine to count at least one of the PDCCH candidates or the CCEs for the CSS set against a minimum among numbers of PDCCH candidates or a minimum among numbers of CCEs for any scheduled cell on the first SCell in at least the PCell, the first SCell, and the second SCell. Any scheduled cell on the first SCell may include any cell that is scheduled via the first SCell through same cell scheduling and/or cross-carrier scheduling.

In certain aspects, the PDCCH candidates and/or CCEs for the CSS set may be counted against a specific corresponding number for a scheduled cell on the secondary cell in which the CSS set is configured. For example, the PDCCH candidates and/or CCEs for the CSS set may be counted against the corresponding numbers for same cell scheduling on the secondary cell (e.g., Y for PDCCH candidates and/or CCEs). The number of PDCCH candidates and the number of non-overlapped CCEs for a Type3-PDCCH CSS set(s) may be counted as part of the corresponding numbers for self-scheduling on the secondary cell in which the CSS set is configured. That is, the UE may not expect the sum of the number of PDCCH candidates (and/or non-overlapped CCEs) for Type3-PDCCH CSS set(s) on the SCell and the number of PDCCH candidates (and/or non-overlapped CCEs) for USS set(s) on the SCell for self-scheduling (e.g., same cell scheduling) to exceed Y.

When determining how to count the PDCCH candidates or the CCEs at step 1004, the UE may determine to count at least one of the PDCCH candidates or the CCEs for the CSS set against a first number of PDCCH candidates or a first number of non-overlapped CCEs for same cell scheduling on the first SCell (e.g., Y for PDCCH candidates and/or CCEs). The UE may treat the first number of PDCCH candidates as a maximum number of PDCCH candidates the UE is expected to monitor between at least the CSS set for common control signaling and a USS set for the same cell scheduling on the first SCell per a span of symbols or a slot. That is, the first number of PDCCH candidates may be considered the maximum number of PDCCH candidates that the UE is expected to monitor per a span of symbols or a slot while monitoring in the CSS set and the USS on the first SCell. In aspects, the maximum may refer to the peak capability of the UE or a constraint that caps a capability of the UE. The UE may treat the first number of CCEs as a maximum number of CCEs the UE is expected to monitor between at least the CSS set for common control signaling and a USS set for the same cell scheduling on the first SCell per a span of symbols or a slot.

The PDCCH candidates and/or CCEs for the CSS set may be counted against the corresponding numbers for cross-carrier scheduling to another secondary cell (e.g., the other secondary cell 102c) on the secondary cell (e.g., Z for PDCCH candidates and/or CCEs). The number of PDCCH candidates and the number of non-overlapped CCEs for the Type3-PDCCH CSS set(s) may be counted as part of the corresponding numbers for cross-carrier scheduling to another secondary cell on the secondary cell and/or for the same cell scheduling on the secondary cell. In aspects, the UE may not expect the sum of the number of PDCCH candidates (and/or non-overlapped CCEs) for Type3-PDCCH CSS set(s) on the SCell and the number of PDCCH candidates (and/or non-overlapped CCEs) for USS set(s) on the SCell for self-scheduling to exceed Y, and the UE may not expect the sum of the number of PDCCH candidates (and/or non-overlapped CCEs) for Type3-PDCCH CSS set(s) on the SCell and the number of PDCCH candidates (and/or non-overlapped CCEs) for USS set(s) on the SCell for cross-carrier scheduling to SCell 2 to exceed Z.

When deciding how to count the PDCCH candidates and/or CCEs at step 1004, the UE may determine to count at least one of the PDCCH candidates or the CCEs for the CSS set against a second number of PDCCH candidates or a second number of non-overlapped CCEs for cross-carrier scheduling on the first SCell, where the cross-carrier scheduling may be specific to another secondary cell such as the second SCell. The UE may treat the second number of PDCCH candidates as a maximum number of PDCCH candidates the UE is expected to monitor between at least the CSS set for common control signaling and a USS set for the cross-carrier scheduling on the first SCell per a span of symbols or a slot. The UE may treat the second number of CCEs as a maximum number of CCEs the UE is expected to monitor among at least the CSS set for common control signaling and a USS set for the cross-carrier scheduling on the first SCell per a span of symbols or a slot.

The PDCCH candidates and/or CCEs for the CSS set may be counted against the corresponding numbers for cross-carrier scheduling to the primary cell (e.g., the primary cell 102a) on the secondary cell (e.g., X2 for PDCCH candidates and/or CCEs). The number of PDCCH candidates and the number of non-overlapped CCEs for the Type3-PDCCH CSS set(s) may be counted as part of the corresponding numbers for cross-carrier scheduling to the PCell on the SCell. The UE may not expect the sum of the number of candidates for Type3-PDCCH CSS set(s) on the SCell and the number of candidates for USS set(s) on the SCell for cross-carrier scheduling to the PCell to exceed X, X2, or the minimum between X2 and X.

When determining how to count blind decodes (e.g., PDCCH candidates) and/or CCEs at step 1004, the UE may determine to count at least one of the PDCCH candidates or the CCEs for the CSS set against a third number of PDCCH candidates or a third number of non-overlapped CCEs for at least cross-carrier scheduling to the PCell on the first SCell (e.g., at least X2 for PDCCH candidates and/or CCEs). In certain cases, the UE may determine to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell (e.g., X for PDCCH candidates and/or CCEs). The UE may treat the third number of PDCCH candidates as a maximum number of PDCCH candidates the UE is expected to monitor between at least the CSS set for common control signaling and a USS set for the cross-carrier scheduling to the PCell on the first SCell per a span of symbols or a slot. The UE may treat the third number of CCEs as a maximum number of CCEs the UE is expected to monitor among at least the CSS set for common control signaling and a USS set for the cross-carrier scheduling to the PCell on the first SCell per a span of symbols or a slot.

In certain cases, a third number of PDCCH candidates or a third number of non-overlapped CCEs are for cross-carrier scheduling to the PCell on the first SCell (e.g., X2 for PDCCH candidates and/or CCEs). A fourth number of PDCCH candidates or a fourth number of non-overlapped CCEs are for cross-carrier scheduling to the PCell on the first SCell and same cell scheduling on the PCell (e.g., X for PDCCH candidates and/or CCEs). At step 1004, the UE may determine to count at least one of the PDCCH candidates or the CCEs for the CSS set against a minimum of the third and fourth numbers of PDCCH candidates and a minimum of the third and fourth numbers of non-overlapped CCEs.

If the UE is configured to receive cross-carrier scheduling to the PCell on the first SCell, the PDCCH candidates and/or CCEs for the CSS set may be counted against the corresponding numbers for any of the scheduled cells on the first SCell, for example, including the PCell, first SCell, and at least the second SCell. The number of PDCCH candidates and the number of non-overlapped CCEs for the Type3-PDCCH CSS set(s) may be counted as part of the corresponding numbers for any of cross-carrier scheduling and/or same cell scheduling on the secondary cell. The UE may not expect the sum of the number of PDCCH candidates (and/or non-overlapped CCEs) for Type3-PDCCH CSS set(s) on the SCell and the number of PDCCH candidates (and/or non-overlapped CCEs) for USS set(s) on the SCell for self-scheduling to exceed Y; the UE may not expect the sum of the number of PDCCH candidates (and/or non-overlapped CCEs) for Type3-PDCCH CSS set(s) on the SCell and the number of PDCCH candidates (and/or non-overlapped CCEs) for USS set(s) on the SCell for cross-carrier scheduling to another SCell to exceed Z; and the UE may not expect the sum of the number of PDCCH candidates (and/or non-overlapped CCEs) for Type3-PDCCH CSS set(s) on the SCell and the number of PDCCH candidates (and/or non-overlapped CCEs) for USS set(s) on the SCell for cross-carrier scheduling to the PCell to exceed X, X2, or the minimum between X and X2. In certain cases, the PDCCH candidates and/or CCEs for the CSS set may be counted against the minimum among Y, X2, and at least Z.

When deciding how to count the PDCCH candidates and/or CCEs, the UE may determine to count at least one of the PDCCH candidates or the CCEs for the CSS set against a first number of PDCCH candidates or a first number of non-overlapped CCEs for same cell scheduling on the first SCell; the UE may determine to count at least one of the PDCCH candidates or the CCEs for the CSS set against a second number of PDCCH candidates or a second number of non-overlapped CCEs for cross-carrier scheduling to at least the second SCell on the first SCell; and the UE may determine to count at least one of the PDCCH candidates or the CCEs for the CSS set against a third number of PDCCH candidates or a third number of non-overlapped CCEs for at least cross-carrier scheduling to the PCell on the first SCell. In certain cases, the third number(s) may further include the corresponding number(s) for the same cell scheduling on the PCell. For example, the UE may determine to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell. In aspects, the UE may determine to count at least one of the PDCCH candidates or the CCEs for the CSS set against the minimum between X and X2.

In aspects, the CSS set may include a search space associated with a specific type of PDCCH, such as a Type 3 PDCCH. In certain cases, the Type 3 PDCCH associated with the CSS set may be for specific RNTI(s) used to scramble the PDCCH candidates. For example, the type 3 PDCCH may include a CRC scrambled by at least one of the INT-RNTI, SFI-RNTI, TPC-PUSCH-RNTI, TPC-PUCCH-RNTI, or TPC-SRS-RNTI.

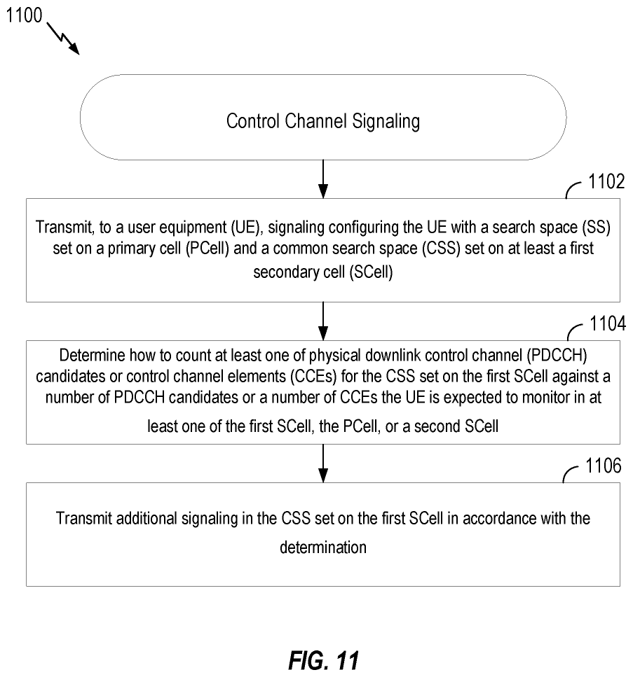

FIG. 11 depicts an example method 1100 for control channel signaling, for example, in accordance with the counting rule(s) for PDCCH candidates and/or CCEs of a common search space on a secondary cell. As used herein, a network entity may refer to a wireless communication device in a radio access network, such as a base station, a remote radio head or antenna panel in communication with a base station, and/or a network controller. The network entity may be a network node. The network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (MC), or a Non-Real Time (Non-RT) MC.

The method 1100 may begin, at step 1102, where the network entity may transmit, to a UE (e.g., UE 104), signaling configuring the UE with a SS set on a PCell (e.g., the primary cell 102a) and a CSS set on at least a first SCell (e.g., the secondary cell 102b). For example, search spaces (e.g., a CSS for Type 0 PDCCH) at step 1102 may be configured via system information, and certain search spaces (e.g., other CSS(s) and/or USS(s)) may be configured via RRC signaling, such as the SearchSpace information element. In aspects, the CSS set may include a search space associated with a specific type of PDCCH, such as a Type 3 PDCCH. In certain cases, the Type 3 PDCCH associated with the CSS set may be for specific RNTI(s) used to scramble the PDCCH candidates. For example, the type 3 PDCCH may include a CRC scrambled by at least one of the INT-RNTI, SFI-RNTI, TPC-PUSCH-RNTI, TPC-PUCCH-RNTI, or TPC-SRS-RNTI.

At step 1104, the network entity may determine how to count at least one of PDCCH candidates or CCEs for the CSS set on the first SCell against a number of PDCCH candidates or a number of CCEs the UE is expected to monitor in at least one of the first SCell, the PCell, or a second SCell (e.g., the other secondary cell 102c). The rules for counting PDCCH candidates and/or CCEs described herein may provide the number of PDCCH candidates and/or the number of non-overlapped CCEs that the UE expects to monitor in search space(s) per slot or per span. In certain cases, the network entity may determine how to count the PDCCH candidates and/or CCEs for the CSS set on the first SCell and configure the UE at step 1102 and/or reconfigure the UE following step 1102 based on the determination.

At step 1106, the network entity may transmit additional signaling in the CSS set on the first SCell in accordance with the determination. In aspects, the additional signaling may also be transmitted in a USS set on the first SCell, for example, carrying same cell scheduling and/or cross-carrier scheduling to the PCell and/or at least the second SCell. Alternatively, the additional signaling at 1106 may be transmitted in the USS set on the first SCell.

In certain aspects, the PDCCH candidates and/or CCEs for the CSS set may be counted against at least one of the corresponding numbers for a scheduled cell on a secondary cell among the primary cell, the secondary cell, and any other secondary cell(s), for example, as described herein with respect to the method 1000. The PDCCH candidates and/or CCEs for the CSS set may be counted against the corresponding numbers for same cell scheduling (e.g., Y for PDCCH candidates and/or CCEs) and/or the corresponding numbers for cross-carrier scheduling (e.g., Z, X2, or X for PDCCH candidates and/or CCEs) on the secondary cell. The PDCCH candidates and/or CCEs for the CSS set may be counted against the corresponding numbers for a specific scheduled cell on the secondary cell or a combination of the corresponding numbers for scheduled cells on the secondary cell. In certain cases, the PDCCH candidates and/or CCEs for the CSS set may be counted against the minimum (or maximum) corresponding number among the scheduled cells on the secondary cell on which the CSS set is configured. In certain cases, the PDCCH candidates and/or CCEs for the CSS set may be counted against the minimum (or maximum) corresponding number among the scheduled cells on the secondary cell. For example, the PDCCH candidates and/or CCEs for the CSS set may be counted against the minimum (or maximum) corresponding number among at least Y, Z, X2, and/or X.

It will be appreciated that the rule(s) for counting PDCCH candidates and/or CCEs described herein may provide one or more advantages. For example, the rule(s) for counting PDCCH candidates and/or CCEs described herein may enable desirable performance (e.g., desirable latencies, data rates, and/or spectral efficiency) in carrier aggregation and/or dual connectivity applications, for example, due to the multiple carriers to facilitate UE-specific and/or common control signaling. In aspects, the rule(s) for counting PDCCH candidates and/or CCEs described herein may enable desirable battery life, for example, due to the power consumption allowed for monitoring control signaling in accordance with the rule(s). In aspects, the rule(s) for counting PDCCH candidates and/or CCEs described herein may enable desirable modem chipset cost and/or size, for example, due to the constraints on control signaling provided by the rule(s).

### Example Wireless Communication Devices

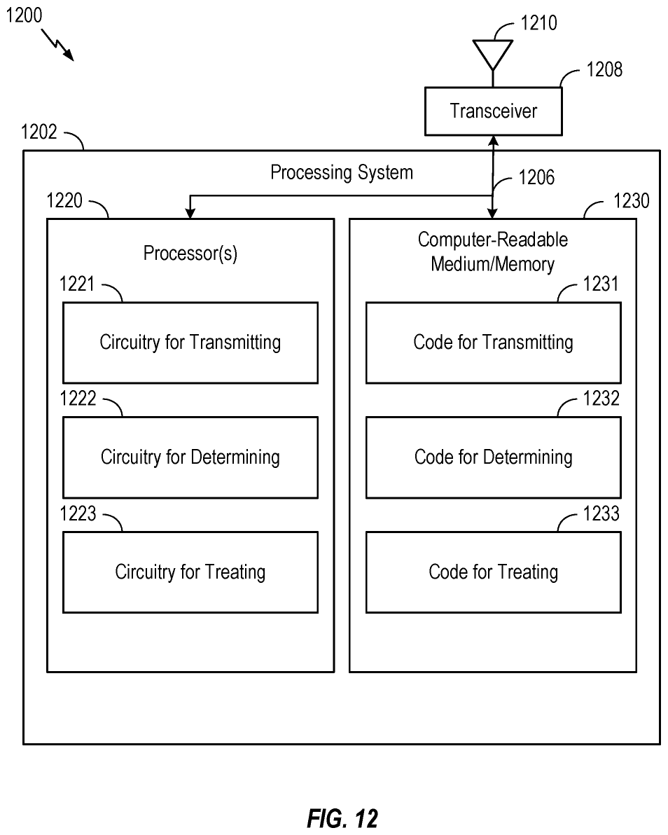

FIG. 12 depicts an example communications device 1200 (e.g., abase station) that includes various components operable, configured, or adapted to perform operations for the techniques disclosed herein, such as the operations depicted and described with respect to FIGS. 9 and 11. In some examples, communication device 1200 may be a base station 102 as described, for example with respect to FIGS. 1 and 2.

Communications device 1200 includes a processing system 1202 coupled to a transceiver 1208 (e.g., a transmitter and/or a receiver). Transceiver 1208 is configured to transmit (or send) and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes one or more processors 1220 coupled to a computer-readable medium/memory 1230 via a bus 1206. In certain aspects, computer-readable medium/memory 1230 is configured to store instructions (e.g., computer-executable code) that when executed by the one or more processors 1220, cause the one or more processors 1220 to perform the operations illustrated in FIGS. 9 and 11, or other operations for performing the various techniques discussed herein for control signaling.

In the depicted example, computer-readable medium/memory 1230 stores code 1231 for transmitting, code 1232 for determining, and/or code 1233 for treating.

In the depicted example, the one or more processors 1220 include circuitry configured to implement the code stored in the computer-readable medium/memory 1230, including circuitry 1221 for transmitting, circuitry 1222 for determining, and/or circuitry 1223 for treating.

Various components of communications device 1200 may provide means for performing the methods described herein, including with respect to FIGS. 9 and 11.

In some examples, means for transmitting or sending (or means for outputting for transmission) may include the transceivers 232a-232t and/or antenna(s) 234a-234t of the base station illustrated in FIG. 2 and/or transceiver 1208 and antenna 1210 of the communication device 1200 in FIG. 12.

In some examples, means for receiving (or means for obtaining) may include the transceivers 232a-232t and/or antenna(s) 234a-234t of the base station illustrated in FIG. 2 and/or transceiver 1208 and antenna 1210 of the communication device 1200 in FIG. 12.

In some examples, means for determining and/or means for treating may include various processing system components, such as: the one or more processors 1220 in FIG. 12, or aspects of the base station 102 depicted in FIG. 2, including receive processor 238, transmit processor 220, TX MIMO processor 230, and/or controller/processor 240 (including control channel component 241).

Notably, FIG. 12 is an example, and many other examples and configurations of communication device 1200 are possible.

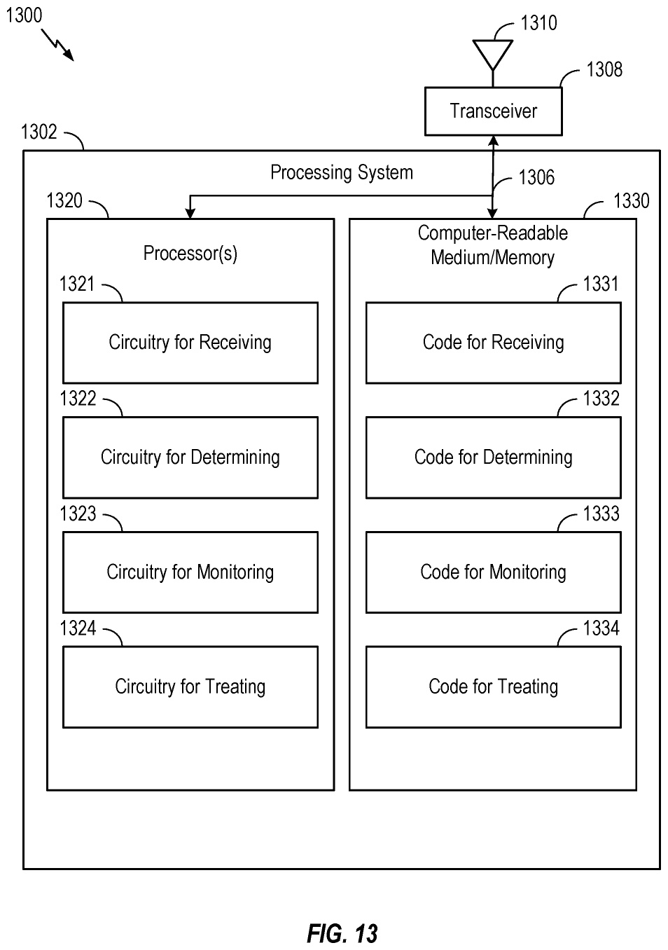

FIG. 13 depicts an example communications device 1300 (e.g., a user equipment) that includes various components operable, configured, or adapted to perform operations for the techniques disclosed herein, such as the operations depicted and described with respect to FIGS. 9 and 10. In some examples, communication device 1300 may be a user equipment 104 as described, for example with respect to FIGS. 1 and 2.

Communications device 1300 includes a processing system 1302 coupled to a transceiver 1308 (e.g., a transmitter and/or a receiver). Transceiver 1308 is configured to transmit (or send) and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes one or more processors 1320 coupled to a computer-readable medium/memory 1330 via a bus 1306. In certain aspects, computer-readable medium/memory 1330 is configured to store instructions (e.g., computer-executable code) that when executed by the one or more processors 1320, cause the one or more processors 1320 to perform the operations illustrated in FIGS. 9 and 10, or other operations for performing the various techniques discussed herein for monitoring control signals.

In the depicted example, computer-readable medium/memory 1330 stores code 1331 for receiving, code 1332 for determining, code 1333 for monitoring, and/or code 1334 for treating.

In the depicted example, the one or more processors 1320 include circuitry configured to implement the code stored in the computer-readable medium/memory 1330, including circuitry 1321 for receiving, circuitry 1322 for determining, circuitry 1323 for monitoring, and/or circuitry 1324 for treating.

Various components of communications device 1300 may provide means for performing the methods described herein, including with respect to FIGS. 9 and 10.

In some examples, means for transmitting or sending (or means for outputting for transmission) may include the transceivers 254a-254r and/or antenna(s) 252a-252r of the user equipment 104 illustrated in FIG. 2 and/or transceiver 1308 and antenna 1310 of the communication device 1300 in FIG. 13.

In some examples, means for receiving (or means for obtaining) may include the transceivers 254a-254r and/or antenna(s) 252a-252r of the user equipment 104 illustrated in FIG. 2 and/or transceiver 1308 and antenna 1310 of the communication device 1300 in FIG. 13.

In some examples, means for determining and/or means for treating may include various processing system components, such as: the one or more processors 1320 in FIG. 13, or aspects of the user equipment 104 depicted in FIG. 2, including receive processor 258, transmit processor 264, TX MIMO processor 266, and/or controller/processor 280 (including control channel component 281).

Notably, FIG. 13 is an example, and many other examples and configurations of communication device 1300 are possible.

### Example Clauses

Implementation examples are described in the following numbered clauses:

Clause 1: A method of wireless communication by a user equipment (UE), comprising: receiving, from a network entity, signaling configuring the UE with a search space (SS) set on a primary cell (PCell) and a common search space (CSS) set on at least a first secondary cell (SCell); determining how to count at least one of physical downlink control channel (PDCCH) candidates or control channel elements (CCEs) for the CSS set on the first SCell against a number of PDCCH candidates or a number of CCEs the UE is expected to monitor in at least one of the first SCell, the PCell, or a second SCell; and monitoring the CSS set on the first SCell in accordance with the determination.

Clause 2: The method of Clause 1, wherein determining how to count comprises determining to count at least one of the PDCCH candidates or the CCEs for the CSS set against a minimum among numbers of PDCCH candidates or a minimum among numbers of CCEs for any scheduled cell on the first SCell in at least the PCell, the first SCell, and the second SCell.

Clause 3: The method according to any one of Clauses 1 or 2, wherein determining how to count comprises determining to count at least one of the PDCCH candidates or the CCEs for the CSS set against a first number of PDCCH candidates or a first number of non-overlapped CCEs for same cell scheduling on the first SCell.

Clause 4: The method of Clause 3, wherein determining how to count comprises treating the first number of PDCCH candidates as a maximum number of PDCCH candidates the UE is expected to monitor between at least the CSS set for common control signaling and a UE-specific search space (USS) set for the same cell scheduling on the first SCell per a span of symbols or a slot.

Clause 5: The method according to any one of Clauses 3 or 4, wherein determining how to count comprises treating the first number of CCEs as a maximum number of CCEs the UE is expected to monitor between at least the CSS set for common control signaling and a USS set for the same cell scheduling on the first SCell per a span of symbols or a slot.

Clause 6: The method according to any one of Clauses 1-5, wherein determining how to count comprises determining to count at least one of the PDCCH candidates or the CCEs for the CSS set against a second number of PDCCH candidates or a second number of non-overlapped CCEs for cross-carrier scheduling on the first SCell.

Clause 7: The method of Clause 6, wherein determining how to count comprises treating the second number of PDCCH candidates as a maximum number of PDCCH candidates the UE is expected to monitor between at least the CSS set for common control signaling and a USS set for the cross-carrier scheduling on the first SCell per a span of symbols or a slot.

Clause 8: The method according to any one of Clauses 6 or 7, wherein determining how to count comprises treating the second number of CCEs as a maximum number of CCEs the UE is expected to monitor among at least the CSS set for common control signaling and a USS set for the cross-carrier scheduling on the first SCell per a span of symbols or a slot.

Clause 9: The method according to any one of Clauses 1-8, wherein determining how to count comprises determining to count at least one of the PDCCH candidates or the CCEs for the CSS set against a third number of PDCCH candidates or a third number of non-overlapped CCEs for at least cross-carrier scheduling to the PCell on the first SCell.

Clause 10: The method of Clause 9, wherein determining how to count comprises treating the third number of PDCCH candidates as a maximum number of PDCCH candidates the UE is expected to monitor between at least the CSS set for common control signaling and a USS set for the cross-carrier scheduling to the PCell on the first SCell per a span of symbols or a slot.

Clause 11: The method according to any one of Clauses 9 or 10, wherein determining how to count comprises treating the third number of CCEs as a maximum number of CCEs the UE is expected to monitor among at least the CSS set for common control signaling and a USS set for the cross-carrier scheduling to the PCell on the first SCell per a span of symbols or a slot.

Clause 12: The method according to any one of Clauses 9-11, wherein determining how to count comprises determining to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell.

Clause 13: The method according to any one of Clauses 1-8, wherein: a third number of PDCCH candidates or a third number of non-overlapped CCEs are for cross-carrier scheduling to the PCell on the first SCell; a fourth number of PDCCH candidates or a fourth number of non-overlapped CCEs are for cross-carrier scheduling to the PCell on the first SCell and same cell scheduling on the PCell; and determining how to count comprises determining to count at least one of the PDCCH candidates or the CCEs for the CSS set against a minimum of the third and fourth numbers of PDCCH candidates and a minimum of the third and fourth numbers of non-overlapped CCEs.

Clause 14: The method of Clause 1, wherein determining how to count comprises: determining to count at least one of the PDCCH candidates or the CCEs for the CSS set against a first number of PDCCH candidates or a first number of non-overlapped CCEs for same cell scheduling on the first SCell; determining to count at least one of the PDCCH candidates or the CCEs for the CSS set against a second number of PDCCH candidates or a second number of non-overlapped CCEs for cross-carrier scheduling on the first SCell; and determining to count at least one of the PDCCH candidates or the CCEs for the CSS set against a third number of PDCCH candidates or a third number of non-overlapped CCEs for at least cross-carrier scheduling to the PCell on the first SCell.

Clause 15: The method of Clause 14, wherein determining how to count comprises determining to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell.

Clause 16: The method according to any one of Clauses 1-15, wherein the CSS set includes a search space associated with a Type 3 physical downlink control channel (PDCCH).

Clause 17: A method of wireless communication by a network entity, comprising: transmitting, to a user equipment (UE), signaling configuring the UE with a search space (SS) set on a primary cell (PCell) and a common search space (CSS) set on at least a first secondary cell (SCell); determining how to count at least one of physical downlink control channel (PDCCH) candidates or control channel elements (CCEs) for the CSS set on the first SCell against a number of PDCCH candidates or a number of CCEs the UE is expected to monitor in at least one of the first SCell, the PCell, or a second SCell; and transmitting additional signaling in the CSS set on the first SCell in accordance with the determination.

Clause 18: The method of Clause 17, wherein determining how to count comprises determining to count at least one of the PDCCH candidates or the CCEs for the CSS set against a minimum among numbers of PDCCH candidates or a minimum among numbers of CCEs for any scheduled cell on the first SCell in at least the PCell, the first SCell, and the second SCell.

Clause 19: The method according to any one of Clauses 17 or 18, wherein determining how to count comprises determining to count at least one of the PDCCH candidates or the CCEs for the CSS set against a first number of PDCCH candidates or a first number of non-overlapped CCEs for same cell scheduling on the first SCell.

Clause 20: The method of Clause 19, wherein determining how to count comprises treating the first number of PDCCH candidates as a maximum number of PDCCH candidates the UE is expected to monitor between at least the CSS set for common control signaling and a UE-specific search space (USS) set for the same cell scheduling on the first SCell per a span of symbols or a slot.

Clause 21: The method according to any one of Clauses 19 or 20, wherein determining how to count comprises treating the first number of CCEs as a maximum number of CCEs the UE is expected to monitor between at least the CSS set for common control signaling and a USS set for the same cell scheduling on the first SCell per a span of symbols or a slot.

Clause 22: The method according to any one of Clauses 17-21, wherein determining how to count comprises determining to count at least one of the PDCCH candidates or the CCEs for the CSS set against a second number of PDCCH candidates or a second number of non-overlapped CCEs for cross-carrier scheduling on the first SCell.

Clause 23: The method of Clause 22, wherein determining how to count comprises treating the second number of PDCCH candidates as a maximum number of PDCCH candidates the UE is expected to monitor between at least the CSS set for common control signaling and a USS set for the cross-carrier scheduling on the first SCell per a span of symbols or a slot.

Clause 24: The method according to any one of Clauses 22 or 23, wherein determining how to count comprises treating the second number of CCEs as a maximum number of CCEs the UE is expected to monitor among at least the CSS set for common control signaling and a USS set for the cross-carrier scheduling on the first SCell per a span of symbols or a slot.

Clause 25: The method according to any one of Clauses 17-24, wherein determining how to count comprises determining to count at least one of the PDCCH candidates or the CCEs for the CSS set against a third number of PDCCH candidates or a third number of non-overlapped CCEs for at least cross-carrier scheduling to the PCell on the first SCell.

Clause 26: The method of Clause 25, wherein determining how to count comprises treating the third number of PDCCH candidates as a maximum number of PDCCH candidates the UE is expected to monitor between at least the CSS set for common control signaling and a USS set for the cross-carrier scheduling to the PCell on the first SCell per a span of symbols or a slot.

Clause 27: The method according to any one of Clauses 25 or 26, wherein determining how to count comprises treating the third number of CCEs as a maximum number of CCEs the UE is expected to monitor among at least the CSS set for common control signaling and a USS set for the cross-carrier scheduling to the PCell on the first SCell per a span of symbols or a slot.

Clause 28: The method according to any one of Clauses 25-27, wherein determining how to count comprises determining to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell.

Clause 29: The method according to any one of Clauses 17-24, wherein: a third number of PDCCH candidates or a third number of non-overlapped CCEs are for cross-carrier scheduling to the PCell on the first SCell; a fourth number of PDCCH candidates or a fourth number of non-overlapped CCEs are for cross-carrier scheduling to the PCell on the first SCell and same cell scheduling on the PCell; and determining how to count comprises determining to count at least one of the PDCCH candidates or the CCEs for the CSS set against a minimum of the third and fourth numbers of PDCCH candidates and a minimum of the third and fourth numbers of non-overlapped CCEs.

Clause 30: The method of Clause 17, wherein determining how to count comprises: determining to count at least one of the PDCCH candidates or the CCEs for the CSS set against a first number of PDCCH candidates or a first number of non-overlapped CCEs for same cell scheduling on the first SCell; determining to count at least one of the PDCCH candidates or the CCEs for the CSS set against a second number of PDCCH candidates or a second number of non-overlapped CCEs for cross-carrier scheduling on the first SCell; and determining to count at least one of the PDCCH candidates or the CCEs for the CSS set against a third number of PDCCH candidates or a third number of non-overlapped CCEs for at least cross-carrier scheduling to the PCell on the first SCell.

Clause 31: The method of Clause 30, determining to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell.

Clause 32: The method according to any one of Clauses 17-31, wherein the CSS set includes a search space associated with a Type 3 physical downlink control channel (PDCCH).

Clause 33: An apparatus, comprising: a memory comprising executable instructions; one or more processors configured to execute the executable instructions and cause the apparatus to perform a method in accordance with any one of Clauses 1-32.

Clause 34: An apparatus, comprising means for performing a method in accordance with any one of Clauses 1-32.

Clause 35: A non-transitory computer-readable medium comprising executable instructions that, when executed by one or more processors of an apparatus, cause the apparatus to perform a method in accordance with any one of Clauses 1-32.

Clause 36: A computer program product embodied on a computer-readable storage medium comprising code for performing a method in accordance with any one of Clauses 1-32.

Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability specifications.

Returning to FIG. 1, various aspects of the present disclosure may be performed within the example wireless communication system 100.

As used herein, the term “cell” can refer to a coverage area of a NodeB and/or a narrowband subsystem serving this coverage area, depending on the context in which the term is used. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an 51 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 102/180 may operate in a traditional sub-6 GHz spectrum, in millimeter wave (mmWave) frequencies, and/or near mmWave frequencies in communication with the UE 104. When the gNB 102/180 operates in mmWave or near mmWave frequencies, the gNB 102/180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication Zlink 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication system 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SC S) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication system 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2μ×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SFN), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Additional Considerations

The preceding description provides examples of control channel monitoring and/or signaling in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the terms “number” and “numbers” may be used interchangeably with the terms “quantity” and “quantities,” respectively.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The following aspects are illustrative only and may be combined with other aspects or teachings described herein, without limitation.

Aspect 1 is an apparatus of wireless communication, including: a memory; and at least one processor coupled to the memory, where the at least one processor is configured to: receive, from a network entity, signaling configuring the apparatus with a search space (SS) set on a primary cell (PCell) and a common search space (CSS) set on at least a first secondary cell (SCell); and monitor at least one of the first SCell, the PCell, or a second SCell based on a count associated with a set of candidates for the CSS set on the first SCell against a number of PDCCH candidates or a number of CCEs, the set of candidates being at least one of physical downlink control channel (PDCCH) candidates or control channel elements (CCEs).

Aspect 2 is the apparatus of aspect 1, where the count is based on counting at least one of the PDCCH candidates or the CCEs for the CSS set against a minimum among one or more quantities of PDCCH candidates or a minimum among one or more quantities of CCEs for any scheduled cell on the first SCell in at least the PCell, the first SCell, and the second SCell, where the number of PDCCH candidates or the number of CCEs comprises the minimum among the one or more quantities of PDCCH candidates or the minimum among the one or more quantities of CCEs.

Aspect 3 is the apparatus of any of aspects 1-2, where the count is based on counting at least one of the PDCCH candidates or the CCEs for the CSS set against a first quantity of PDCCH candidates or a first quantity of non-overlapped CCEs for same cell scheduling on the first SCell, where the number of PDCCH candidates or the number of CCEs comprises the first quantity of PDCCH candidates or the first quantity of non-overlapped CCEs.

Aspect 4 is the apparatus of any of aspects 1-3, where the count is based on treating the first quantity of PDCCH candidates as a maximum quantity of PDCCH candidates, and where the at least one processor is configured to the monitor between at least the CSS set for common control signaling and an apparatus-specific search space (USS) set for the same cell scheduling on the first SCell per a span of symbols or a slot.

Aspect 5 is the apparatus of any of aspects 1-4, where the count is based on treating the first quantity of CCEs as a maximum quantity of CCEs, and where the at least one processor is configured to monitor between at least the CSS set for common control signaling and a USS set for the same cell scheduling on the first SCell per a span of symbols or a slot.

Aspect 6 is the apparatus of any of aspects 1-5, where the count is based on counting at least one of the PDCCH candidates or the CCEs for the CSS set against a second quantity of PDCCH candidates or a second quantity of non-overlapped CCEs for cross-carrier scheduling on the first SCell, where the number of PDCCH candidates or the number of CCEs comprises the second quantity of PDCCH candidates or the second quantity of non-overlapped CCEs.

Aspect 7 is the apparatus of any of aspects 1-6, where the count is based on treating the second quantity of PDCCH candidates as a maximum quantity of PDCCH candidates, and where the at least one processor is configured to monitor between at least the CSS set for common control signaling and a USS set for the cross-carrier scheduling on the first SCell per a span of symbols or a slot.

Aspect 8 is the apparatus of any of aspects 1-7, where the count is based on treating the second quantity of CCEs as a maximum quantity of CCEs, and where the at least one processor is configured to monitor among at least the CSS set for common control signaling and a USS set for the cross-carrier scheduling on the first SCell per a span of symbols or a slot.

Aspect 9 is the apparatus of any of aspects 1-8, where the count is based on counting at least one of the PDCCH candidates or the CCEs for the CSS set against a third quantity of PDCCH candidates or a third quantity of non-overlapped CCEs for at least cross-carrier scheduling to the PCell on the first SCell, where the number of PDCCH candidates or the number of CCEs comprises the third quantity of PDCCH candidates or the second quantity of non-overlapped CCEs.

Aspect 10 is the apparatus of any of aspects 1-9, where the count is based on treating the third quantity of PDCCH candidates as a maximum quantity of PDCCH candidates, and where the at least one processor is configured to monitor between at least the CSS set for common control signaling and a USS set for the cross-carrier scheduling to the PCell on the first SCell per a span of symbols or a slot.

Aspect 11 is the apparatus of any of aspects 1-10, where the count is based on treating the third quantity of CCEs as a maximum number of CCEs, and where the at least one processor is configured to monitor among at least the CSS set for common control signaling and a USS set for the cross-carrier scheduling to the PCell on the first SCell per a span of symbols or a slot.

Aspect 12 is the apparatus of any of aspects 1-11, where the count is based on counting at least one of the PDCCH candidates or the CCEs for the CSS set against the third quantity of PDCCH candidates or the quantity number of non-overlapped CCEs for cross-carrier scheduling to the PCell on the first SCell and same cell scheduling on the PCell.

Aspect 13 is the apparatus of any of aspects 1-12, where: a third quantity of PDCCH candidates or a third quantity of non-overlapped CCEs are for cross-carrier scheduling to the PCell on the first SCell; and a fourth quantity of PDCCH candidates or a fourth quantity of non-overlapped CCEs are for the cross-carrier scheduling to the P Cell on the first SCell and same cell scheduling on the PCell; where the count is based on counting at least one of the PDCCH candidates or the CCEs for the CSS set against a minimum of the third quantity and the fourth quantity of PDCCH candidates and a minimum of the third quantity and the fourth quantity of non-overlapped CCEs, and where the number of PDCCH candidates or the number of CCEs comprises the minimum of the third quantity and the fourth quantity of PDCCH candidates and the minimum of the third quantity and the fourth quantity of non-overlapped CCEs.

Aspect 14 is the apparatus of any of aspects 1-13, where the count is based on: counting at least one of the PDCCH candidates or the CCEs for the CSS set against a first quantity of PDCCH candidates or a first quantity of non-overlapped CCEs for same cell scheduling on the first SCell; counting at least one of the PDCCH candidates or the CCEs for the CSS set against a second quantity of PDCCH candidates or a second quantity of non-overlapped CCEs for cross-carrier scheduling on the first SCell; and counting at least one of the PDCCH candidates or the CCEs for the CSS set against a third quantity of PDCCH candidates or a third quantity of non-overlapped CCEs for at least the cross-carrier scheduling to the PCell on the first SCell, and where the number of PDCCH candidates or the number of CCEs comprises the first quantity of PDCCH candidates or the first quantity of non-overlapped CEs, the second quantity of PDCCH candidates or the second quantity of non-overlapped CEs, or the third quantity of PDCCH candidate s or the third quantity of non-overlapped CEs.

Aspect 15 is the apparatus of any of aspects 1-14, where the count is based on counting at least one of the PDCCH candidates or the CCEs for the CSS set against the third quantity of PDCCH candidates or the third quantity of non-overlapped CCEs for the cross-carrier scheduling to the PCell on the first SCell and the same cell scheduling on the PCell.

Aspect 16 is the apparatus of any of aspects 1-15, where the CSS set include s a search space associated with a physical downlink control channel (PDCCH) type, where the PDCCH type is associated with one or more common control signals.

Aspect 17 is a network entity for wireless communication, comprising: a memory; and at least one processor coupled to the memory, where the at least one processor is configured to: transmit, for a user equipment (UE), signaling configuring the UE with a search space (SS) set on a primary cell (PCell) and a common search space (CSS) set on at least a first secondary cell (SCell); determine how to count at least one of physical downlink control channel (PDCCH) candidates or control channel elements (CCEs) for the CSS set on the first SCell against a number of PDCCH candidates or a number of CCEs; and transmit additional signaling in the CSS set on the first SCell in accordance with the determination.

Aspect 18 is the network entity of aspect 17, where to determine how to count, the at least one processor is configured to determine to count at least one of the PDCCH candidates or the CCEs for the CSS set against a minimum among one or more quantities of PDCCH candidates or a minimum among one or more quantities of CCEs for any scheduled cell on the first SCell in at least the PCell, the first SCell, and a second SCell, where the number of PDCCH candidates or the number of CCEs comprises the minimum among the one or more quantities of PDCCH candidates or the minimum among the one or more quantities of CCEs.

Aspect 19 is the network entity of any of aspects 17-18, where to determine how to count, the at least one processor is configured to determine to count at least one of the PDCCH candidates or the CCEs for the CSS set against a first quantity of PDCCH candidates or a first quantity of non-overlapped CCEs for same cell scheduling on the first SCell, where the number of PDCCH candidates or the number of CCEs comprises the first quantity of PDCCH candidates or the first quantity of non-overlapped CCEs.

Aspect 20 is the network entity of any of aspects 17-19, where to determine how to count, the at least one processor is configured to treat the first quantity of PDCCH candidates as a maximum quantity of PDCCH candidates the UE is expected to monitor between at least the CSS set for common control signaling and a UE-specific search space (USS) set for the same cell scheduling on the first SCell per a span of symbols or a slot.

Aspect 21 is the network entity of any of aspects 17-20, where to determine how to count, the at least one processor is configured to determine treat the first quantity of CCEs as a maximum quantity of CCEs associated with at least the CSS set for common control signaling and a USS set for the same cell scheduling on the first SCell per a span of symbols or a slot.

Aspect 22 is the network entity of any of aspects 17-21, where to determine how to count, the at least one processor is configured to determine to count at least one of the PDCCH candidates or the CCEs for the CSS set against a second quantity of PDCCH candidates or a second quantity of non-overlapped CCEs for cross-carrier scheduling on the first SCell, where the number of PDCCH candidates or the number of CCEs comprises the second quantity of PDCCH candidates or the second quantity of non-overlapped CCEs.

Aspect 23 is the network entity of any of aspects 17-22, where to determine how to count, the at least one processor is configured to treat the second number of PDCCH candidates as a maximum number of PDCCH candidates the UE is expected to monitor between at least the CSS set for common control signaling and a USS set for the cross-carrier scheduling on the first SCell per a span of symbols or a slot.

Aspect 24 is the network entity of any of aspects 17-23, where to determine how to count, the at least one processor is configured to treat the second quantity of CCEs as a maximum quantity of CCEs the UE is expected to monitor among at least the CSS set for common control signaling and a USS set for the cross-carrier scheduling on the first SCell per a span of symbols or a slot.

Aspect 25 is the network entity of any of aspects 17-24, where to determine how to count, the at least one processor is configured to determine to count at least one of the PDCCH candidates or the CCEs for the CSS set against a third quantity of PDCCH candidates or a third quantity of non-overlapped CCEs for at least cross-carrier scheduling to the PCell on the first SCell, where the number of PDCCH candidates or the number of CCEs comprises the third quantity of PDCCH candidates or the second quantity of non-overlapped CCEs.

Aspect 26 is the network entity of any of aspects 17-25, where to determine how to count, the at least one processor is configured to treat the third quantity of PDCCH candidates as a maximum quantity of PDCCH candidates associated with at least the CSS set for common control signaling and a USS set for the cross-carrier scheduling to the PCell on the first SCell per a span of symbols or a slot.

Aspect 27 is the network entity of any of aspects 17-26, where to determine how to count, the at least one processor is configured to treat the third quantity of CCEs as a maximum quantity of CCEs associated with at least the CSS set for common control signaling and a USS set for the cross-carrier scheduling to the PCell on the first SCell per a span of symbols or a slot.

Aspect 28 is the network entity of any of aspects 17-27, where to determine how to count, the at least one processor is configured to determine to count at least one of the PDCCH candidates or the CCEs for the CSS set against the third quantity of PDCCH candidates or the third quantity of non-overlapped CCEs for cross-carrier scheduling to the PCell on the first SCell and same cell scheduling on the PCell.

Aspect 28 is the network entity of any of aspects 17-27, where to determine how to count, the at least one processor is configured to determine to count at least one of the PDCCH candidates or the CCEs for the CSS set against the third number of PDCCH candidates or the third number of non-overlapped CCEs for cross-carrier scheduling to the PCell on the first SCell and same cell scheduling on the PCell.

Aspect 29 is the network entity of any of aspects 17-28, where: a third quantity of PDCCH candidates or a third quantity of non-overlapped CCEs are for cross-carrier scheduling to the PCell on the first SCell; a fourth quantity of PDCCH candidates or a fourth quantity of non-overlapped CCEs are for cross-carrier scheduling to the PCell on the first SCell and same cell scheduling on the PCell; and to determine how to count, the at least one processor is configured to count at least one of the PDCCH candidates or the CCEs for the CSS set against a minimum of the third quantity and the fourth quantity of PDCCH candidates and a minimum of the third quantity and the fourth quantity of non-overlapped CCEs, and where the number of PDCCH candidates or the number of CCEs comprises the minimum of the third quantity and the fourth quantity of PDCCH candidates and the minimum of the third quantity and the fourth quantity of non-overlapped CCEs.

Aspect 30 is the network entity of any of aspects 17-29, where to determine how to count, the at least one processor is configured to: determine to count at least one of the PDCCH candidates or the CCEs for the CSS set against a first quantity of PDCCH candidates or a first quantity of non-overlapped CCEs for same cell scheduling on the first SCell; determine to count at least one of the PDCCH candidates or the CCEs for the CSS set against a second quantity of PDCCH candidates or a second quantity of non-overlapped CCEs for cross-carrier scheduling on the first SCell; and determine to count at least one of the PDCCH candidates or the CCEs for the CSS set against a third quantity of PDCCH candidates or a third quantity of non-overlapped CCEs for at least the cross-carrier scheduling to the PCell on the first SCell, and where the number of PDCCH candidates or the number of CCEs comprises the first quantity of PDCCH candidates or the first quantity of non-overlapped CEs, the second quantity of PDCCH candidates or the second quantity of non-overlapped CEs, or the third quantity of PDCCH candidates or the third quantity of non-overlapped CEs.

Aspect 31 is the network entity of any of aspects 17-30, to determine how to count, the at least one processor is configured to count at least one of the PDCCH candidates or the CCEs for the CSS set against the third quantity of PDCCH candidates or the third quantity of non-overlapped CCEs for cross-carrier scheduling to the PCell on the first SCell and same cell scheduling on the PCell.

Aspect 32 is the network entity of any of aspects 17-31, where the CSS set includes a search space associated with a physical downlink control channel (PDCCH) type, where the PDCCH type is associated with one or more common control signals.

Aspect 33 is a method of wireless communication at a network entity for implementing any of aspects 1 to 16.

Aspect 34 is a method of wireless communication at a network entity for implementing any of aspects 17 to 21.

Aspect 35 is an apparatus including means for implementing any of aspects 1 to 16.

Aspect 36 is an apparatus including means for implementing any of aspects 17 to 21.

Aspect 37 is a non-transitory computer-readable medium storing computer executable code, where the code when executed by a processor causes the processor to implement any of aspects 1 to 16.

Aspect 38 is a non-transitory computer-readable medium storing computer executable code, where the code when executed by a processor causes the processor to implement any of aspects 17 to 21.

What is claimed is:

1. An apparatus for wireless communication, comprising:
a memory; and
at least one processor coupled to the memory, wherein the at least one processor is configured to:
receive, from a network entity, signaling configuring the apparatus with a search space (SS) set on a primary cell (PCell) and a common search space (CSS) set on at least a first secondary cell (SCell); and
monitor at least one of the first SCell, the PCell, or a second SCell based on a count associated with a set of candidates for the CSS set on the first SCell against a number of PDCCH candidates or a number of CCEs, the set of candidates being at least one of physical downlink control channel (PDCCH) candidates or control channel elements (CCEs).

2. The apparatus of claim 1, wherein the count is based on counting at least one of the PDCCH candidates or the CCEs for the CSS set against a minimum among one or more quantities of PDCCH candidates or a minimum among one or more quantities of CCEs for any scheduled cell on the first SCell in at least the PCell, the first SCell, and the second SCell, wherein the number of PDCCH candidates or the number of CCEs comprises the minimum among the one or more quantities of PDCCH candidates or the minimum among the one or more quantities of CCEs.

3. The apparatus of claim 1, wherein the count is based on counting at least one of the PDCCH candidates or the CCEs for the CSS set against a first quantity of PDCCH candidates or a first quantity of non-overlapped CCEs for same cell scheduling on the first SCell, wherein the number of PDCCH candidates or the number of CCEs comprises the first quantity of PDCCH candidates or the first quantity of non-overlapped CCEs.

4. The apparatus of claim 3, wherein the count is based on treating the first quantity of PDCCH candidates as a maximum quantity of PDCCH candidates, and wherein the at least one processor is configured to the monitor between at least the CSS set for common control signaling and an apparatus-specific search space (USS) set for the same cell scheduling on the first SCell per a span of symbols or a slot.

5. The apparatus of claim 3, wherein the count is based on treating the first quantity of CCEs as a maximum quantity of CCEs, and wherein the at least one processor is configured to monitor between at least the CSS set for common control signaling and a USS set for the same cell scheduling on the first SCell per a span of symbols or a slot.

6. The apparatus of claim 3, wherein the count is based on counting at least one of the PDCCH candidates or the CCEs for the CSS set against a second quantity of PDCCH candidates or a second quantity of non-overlapped CCEs for cross-carrier scheduling on the first SCell, wherein the number of PDCCH candidates or the number of CCEs comprises the second quantity of PDCCH candidates or the second quantity of non-overlapped CCEs.

7. The apparatus of claim 6, wherein the count is based on treating the second quantity of PDCCH candidates as a maximum quantity of PDCCH candidates, and wherein the at least one processor is configured to monitor between at least the CSS set for common control signaling and a USS set for the cross-carrier scheduling on the first SCell per a span of symbols or a slot.

8. The apparatus of claim 6, wherein the count is based on treating the second quantity of CCEs as a maximum quantity of CCEs, and wherein the at least one processor is configured to monitor among at least the CSS set for common control signaling and a USS set for the cross-carrier scheduling on the first SCell per a span of symbols or a slot.

9. The apparatus of claim 6, wherein the count is based on counting at least one of the PDCCH candidates or the CCEs for the CSS set against a third quantity of PDCCH candidates or a third quantity of non-overlapped CCEs for at least cross-carrier scheduling to the PCell on the first SCell, wherein the number of PDCCH candidates or the number of CCEs comprises the third quantity of PDCCH candidates or the second quantity of non-overlapped CCEs.

10. The apparatus of claim 9, wherein the count is based on treating the third quantity of PDCCH candidates as a maximum quantity of PDCCH candidates, and wherein the at least one processor is configured to monitor between at least the CSS set for common control signaling and a USS set for the cross-carrier scheduling to the PCell on the first SCell per a span of symbols or a slot.

11. The apparatus of claim 9, wherein the count is based on treating the third quantity of CCEs as a maximum number of CCEs, and wherein the at least one processor is configured to monitor among at least the CSS set for common control signaling and a USS set for the cross-carrier scheduling to the PCell on the first SCell per a span of symbols or a slot.

12. The apparatus of claim 9, wherein the count is based on counting at least one of the PDCCH candidates or the CCEs for the CSS set against the third quantity of PDCCH candidates or the quantity number of non-overlapped CCEs for cross-carrier scheduling to the PCell on the first SCell and same cell scheduling on the P Cell.

13. The apparatus of claim 1, wherein:
a third quantity of PDCCH candidates or a third quantity of non-overlapped CCEs are for cross-carrier scheduling to the PCell on the first SCell; and
a fourth quantity of PDCCH candidates or a fourth quantity of non-overlapped CCEs are for the cross-carrier scheduling to the PCell on the first SCell and same cell scheduling on the PCell;
wherein the count is based on counting at least one of the PDCCH candidates or the CCEs for the CSS set against a minimum of the third quantity and the fourth quantity of PDCCH candidates and a minimum of the third quantity and the fourth quantity of non-overlapped CCEs, and wherein the number of PDCCH candidates or the number of CCEs comprises the minimum of the third quantity and the fourth quantity of PDCCH candidates and the minimum of the third quantity and the fourth quantity of non-overlapped CCEs.

14. The apparatus of claim 1, wherein the count is based on:
counting at least one of the PDCCH candidates or the CCEs for the CSS set against a first quantity of PDCCH candidates or a first quantity of non-overlapped CCEs for same cell scheduling on the first SCell;
counting at least one of the PDCCH candidates or the CCEs for the CSS set against a second quantity of PDCCH candidates or a second quantity of non-overlapped CCEs for cross-carrier scheduling on the first SCell; and
counting at least one of the PDCCH candidates or the CCEs for the CSS set against a third quantity of PDCCH candidates or a third quantity of non-overlapped CCEs for at least the cross-carrier scheduling to the PCell on the first SCell, and wherein the number of PDCCH candidates or the number of CCEs comprises the first quantity of PDCCH candidates or the first quantity of non-overlapped CEs, the second quantity of PDCCH candidates or the second quantity of non-overlapped CEs, or the third quantity of PDCCH candidates or the third quantity of non-overlapped CEs.

15. The apparatus of claim 14, wherein the count is based on counting at least one of the PDCCH candidates or the CCEs for the CSS set against the third quantity of PDCCH candidates or the third quantity of non-overlapped CCEs for the cross-carrier scheduling to the PCell on the first SCell and the same cell scheduling on the PCell.

16. The apparatus of claim 1, wherein the CSS set includes a search space associated with a physical downlink control channel (PDCCH) type, wherein the PDCCH type is associated with one or more common control signals.

17. A network entity for wireless communication, comprising:
a memory; and
at least one processor coupled to the memory, wherein the at least one processor is configured to:
transmit, for a user equipment (UE), signaling configuring the UE with a search space (SS) set on a primary cell (PCell) and a common search space (CSS) set on at least a first secondary cell (SCell);
determine how to count at least one of physical downlink control channel (PDCCH) candidates or control channel elements (CCEs) for the CSS set on the first SCell against a number of PDCCH candidates or a number of CCEs; and
transmit additional signaling in the CSS set on the first SCell in accordance with the determination.

18. The network entity of claim 17, wherein to determine how to count, the at least one processor is configured to determine to count at least one of the PDCCH candidates or the CCEs for the CSS set against a minimum among one or more quantities of PDCCH candidates or a minimum among one or more quantities of CCEs for any scheduled cell on the first SCell in at least the PCell, the first SCell, and a second SCell, wherein the number of PDCCH candidates or the number of CCEs comprises the minimum among the one or more quantities of PDCCH candidates or the minimum among the one or more quantities of CCEs.

19. The network entity of claim 17, wherein to determine how to count, the at least one processor is configured to determine to count at least one of the PDCCH candidates or the CCEs for the CSS set against a first quantity of PDCCH candidates or a first quantity of non-overlapped CCEs for same cell scheduling on the first SCell, wherein the number of PDCCH candidates or the number of CCEs comprises the first quantity of PDCCH candidates or the first quantity of non-overlapped CCEs.

20. The network entity of claim 19, wherein to determine how to count, the at least one processor is configured to treat the first quantity of PDCCH candidates as a maximum quantity of PDCCH candidates the UE is expected to monitor between at least the CSS set for common control signaling and a UE-specific search space (USS) set for the same cell scheduling on the first SCell per a span of symbols or a slot.

21. The network entity of claim 19, wherein to determine how to count, the at least one processor is configured to determine treat the first quantity of CCEs as a maximum quantity of CCEs associated with at least the CSS set for common control signaling and a USS set for the same cell scheduling on the first SCell per a span of symbols or a slot.

22. The network entity of claim 19, wherein to determine how to count, the at least one processor is configured to determine to count at least one of the PDCCH candidates or the CCEs for the CSS set against a second quantity of PDCCH candidates or a second quantity of non-overlapped CCEs for cross-carrier scheduling on the first SCell, wherein the number of PDCCH candidates or the number of CCEs comprises the second quantity of PDCCH candidates or the second quantity of non-overlapped CCEs.

23. The network entity of claim 22, wherein to determine how to count, the at least one processor is configured to treat the second number of PDCCH candidates as a maximum number of PDCCH candidates the UE is expected to monitor between at least the CSS set for common control signaling and a USS set for the cross-carrier scheduling on the first SCell per a span of symbols or a slot.

24. The network entity of claim 22, wherein to determine how to count, the at least one processor is configured to treat the second quantity of CCEs as a maximum quantity of CCEs the UE is expected to monitor among at least the CSS set for common control signaling and a USS set for the cross-carrier scheduling on the first SCell per a span of symbols or a slot.

25. The network entity of claim 17, wherein to determine how to count, the at least one processor is configured to determine to count at least one of the PDCCH candidates or the CCEs for the CSS set against a third quantity of PDCCH candidates or a third quantity of non-overlapped CCEs for at least cross-carrier scheduling to the PCell on the first SCell, wherein the number of PDCCH candidates or the number of CCEs comprises the third quantity of PDCCH candidates or the third quantity of non-overlapped CCEs.

26. The network entity of claim 25, wherein to determine how to count, the at least one processor is configured to treat the third quantity of PDCCH candidates as a maximum quantity of PDCCH candidates associated with at least the CSS set for common control signaling and a USS set for the cross-carrier scheduling to the PCell on the first SCell per a span of symbols or a slot.

27. The network entity of claim 25, wherein to determine how to count, the at least one processor is configured to treat the third quantity of CCEs as a maximum quantity of CCEs associated with at least the CSS set for common control signaling and a USS set for the cross-carrier scheduling to the PCell on the first SCell per a span of symbols or a slot.

28. The network entity of claim 25, wherein to determine how to count, the at least one processor is configured to determine to count at least one of the PDCCH candidates or the CCEs for the CSS set against the third quantity of PDCCH candidates or the third quantity of non-overlapped CCEs for cross-carrier scheduling to the PCell on the first SCell and same cell scheduling on the PCell.

29. A method of wireless communication performed by a user equipment (UE), comprising:
receiving, from a network entity, signaling configuring the UE with a search space (SS) set on a primary cell (PCell) and a common search space (CSS) set on at least a first secondary cell (SCell); and
monitoring at least one of the first SCell, the PCell, or a second SCell based on a count associated with a set of candidates for the CSS set on the first SCell against a number of PDCCH candidates or a number of CCEs, the set of candidates being at least one of physical downlink control channel (PDCCH) candidates or control channel elements (CCEs).

30. A method of wireless communication performed by a network entity, comprising:
transmitting, for a user equipment (UE), signaling configuring the UE with a search space (SS) set on a primary cell (PCell) and a common search space (CSS) set on at least a first secondary cell (SCell);
determining how to count at least one of physical downlink control channel (PDCCH) candidates or control channel elements (CCEs) for the CSS set on the first SCell against a number of PDCCH candidates or a number of CCEs; and
transmitting additional signaling in the CSS set on the first SCell in accordance with the determination.
